(19) United States
(12) Patent Application Publication
(10) Pub. No.: US 2026/0292446 A1
(43) Pub. Date: Sep. 24, 2026

(54) POSITIONING ADAPTATION TO CHALLENGING THERMAL CONDITION

(71) Applicant: QUALCOMM Incorporated, San Diego, CA (US)

(72) Inventors: Avinash SHRIVASTAVA, Hyderabad (IN); Stephen William EDGE, Escondido, CA (US)

(21) Appl. No.: 19/087,186

(22) Filed: Mar. 21, 2025

(51) Int. Cl. H04W 4/029; H04W 28/24; H04W 84/06

(52) U.S. Cl. CPC H04W 4/029; H04W 28/24; H04W 84/06

(57) ABSTRACT

Techniques are described for adjusting positioning operations in a mobile dependent on thermal conditions. A method can include obtaining at least one temperature associated with the mobile device and determining, e.g., reducing, a level of service of a positioning function of the mobile device. The positioning function can include positioning operations including measuring at least one wireless positioning signal received by the mobile device and estimating a position of the mobile device. Positioning signals may include GNSS, WiFi and cellular signals and estimating a position may have accuracy and latency requirements. Reducing the level of service of the positioning function can include reducing at least one level of service of at least one of the positioning operations of the positioning function based on the at least one temperature exceeding at least one first temperature threshold.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

It is often desirable to know the location and/or motion (e.g., speed or velocity) of a user equipment (UE), e.g., a cellular phone, with the terms “location” and “position” being synonymous and used interchangeably herein. A location services (LCS) client may desire to know the location of the UE and may communicate with a location server in order to request the location of the UE. The location server and the UE may exchange messages, as appropriate, to obtain a location estimate for the UE. The location server may return the location estimate to the LCS client, e.g., for use in one or more applications. In other cases, a UE (e.g., a user of the UE or an application running on the UE) may need the UE location which may lead to similar interaction with a location server to obtain the location, or the UE may determine its location without interaction with a location server. In such cases as these, thermal conditions inside and/or outside the UE may affect an ability to determine the location.

### SUMMARY

An example for providing positioning service for a mobile device includes: obtaining at least one temperature associated with the mobile device; determining a level of service of a positioning function of the mobile device, corresponding to one or more available positioning operations, and one or more selected positioning operations from the one or more available positioning operations, based on the at least one temperature exceeding at least one first temperature threshold; and determining position information based on the one or more selected positioning operations of the one or more available positioning operations, the position information including one or more positioning signal measurements, or one or more position estimates, or any combination thereof.

An example apparatus includes: at least one memory; at least one transceiver; and at least one processor, communicatively coupled to the at least one memory and the at least one transceiver, configured to: obtain at least one temperature associated with a mobile device; determine a level of service of a positioning function of the mobile device, corresponding to one or more available positioning operations, and one or more selected positioning operations from the one or more available positioning operations, based on the at least one temperature exceeding at least one first temperature threshold; and determine position information based on the one or more selected positioning operations of the one or more available positioning operations, the position information including one or more positioning signal measurements, or one or more position estimates, or any combination thereof.

Another example apparatus includes: means for obtaining at least one temperature associated with a mobile device; means for determining a level of service of a positioning function of the mobile device, corresponding to one or more available positioning operations, and one or more selected positioning operations from the one or more available positioning operations, based on the at least one temperature exceeding at least one first temperature threshold; and means for determining position information based on the one or more selected positioning operations of the one or more available positioning operations, the position information including one or more positioning signal measurements, or one or more position estimates, or any combination thereof.

An example non-transitory, processor-readable storage medium includes processor-readable instructions to cause at least one processor of an apparatus, for providing positioning service for a mobile device, to: obtain at least one temperature associated with the mobile device; determine a level of service of a positioning function of the mobile device, corresponding to one or more available positioning operations, and one or more selected positioning operations from the one or more available positioning operations, based on the at least one temperature exceeding at least one first temperature threshold; and determine position information based on the one or more selected positioning operations of the one or more available positioning operations, the position information including one or more positioning signal measurements, or one or more position estimates, or any combination thereof.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example user equipment.

FIG. 6 is a block diagram of an example network entity.

FIG. 7 illustrates an example positioning environment for determining position estimates of a mobile device such as the user equipment shown in FIG. 5.

FIG. 8 is a block diagram of components of an example of the user equipment shown in FIG. 5, including multiple signal chains.

FIG. 9 is a process and signaling flow for determining a position estimate for the user equipment shown in FIG. 5 in challenging thermal conditions.

FIG. 10 is a block diagram showing example sets of different user equipment functionality for use under different thermal conditions.

FIG. 11 is another block diagram showing example sets of different user equipment functionality for use under different thermal conditions.

FIG. 12 is a block flow diagram of a method for providing positioning service for a mobile device.

### DETAILED DESCRIPTION

Techniques are discussed herein for positioning of a device (e.g., a mobile device) in challenging thermal conditions. For example, based on one or more temperature thresholds being exceeded, a functionality of a mobile device may be set (e.g., reduced relative to a desired functionality), e.g., to allow for obtaining position information so that an acceptably-accurate position estimate for the mobile device may be determined within an acceptable time frame. One or more temperatures associated with the mobile device (e.g., one or more temperatures internal to the mobile device and/or one or more temperatures external to the mobile device (e.g., of the environment containing the mobile device)) may be monitored and device functionality set (e.g., adjusted) to try to prevent the mobile device from being unable to determine and/or report acceptable position information. The functionality may be set by increasing functionality until a threshold temperature is exceeded, or by setting the functionality according to one or more factors including temperature (e.g., according to a table associating functionality and temperature), or by reducing functionality from a default functionality based on the one or more temperatures, or by another mechanism. There may be multiple levels of challenging thermal conditions with each level corresponding to different functionality, with less functionality (e.g., greater functionality reduction) corresponding to more challenging thermal condition(s). Satellite positioning system bands and/or constellations may be adjusted based on thermal conditions. For example, constellations may be reduced in a prioritized order (e.g., IRNSS, Beidou, GLONASS, Galileo), satellite positioning system bands reduced in prioritized order (e.g., L2, then L5), number of satellite vehicle signals reduced, and/or satellite vehicle signal measurement time increased, etc. based on thermal conditions. The discussion herein focuses on reducing level of service (e.g., reducing functionality) but the level of service may be set to a level (e.g., based on one or more temperatures) without assuming a level of service and reducing the level of service. For example, a level of service may be set based on a stored correspondence between different temperatures and different levels of service. As another example, a low functionality may be used as a default functionality, and the functionality increased based on temperature, e.g., increasing functionality up to an acceptable functionality in view of the temperature(s). Further, the examples discussed above are not exhaustive, and other examples may be implemented.

Items and/or techniques described herein may provide one or more of the following capabilities, and possibly one or more other capabilities not mentioned. Acceptable mobile device positioning (i.e., determination of mobile device position estimate) may be accomplished in the presence of one or more challenging thermal conditions. A device (e.g., a PSAP (Public Safety Answering Point) or a location server) may be able to adjust mobile device operation to enable locating a mobile device in emergency and non-emergency situations without the mobile device losing an ability to communicate with a network to determine a location of the mobile device. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements. Various positioning methods for a UE are currently defined which can utilize reference signals transmitted by base stations in 4G LTE or 5G NR wireless networks such as Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” a “device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a gNodeB, (gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

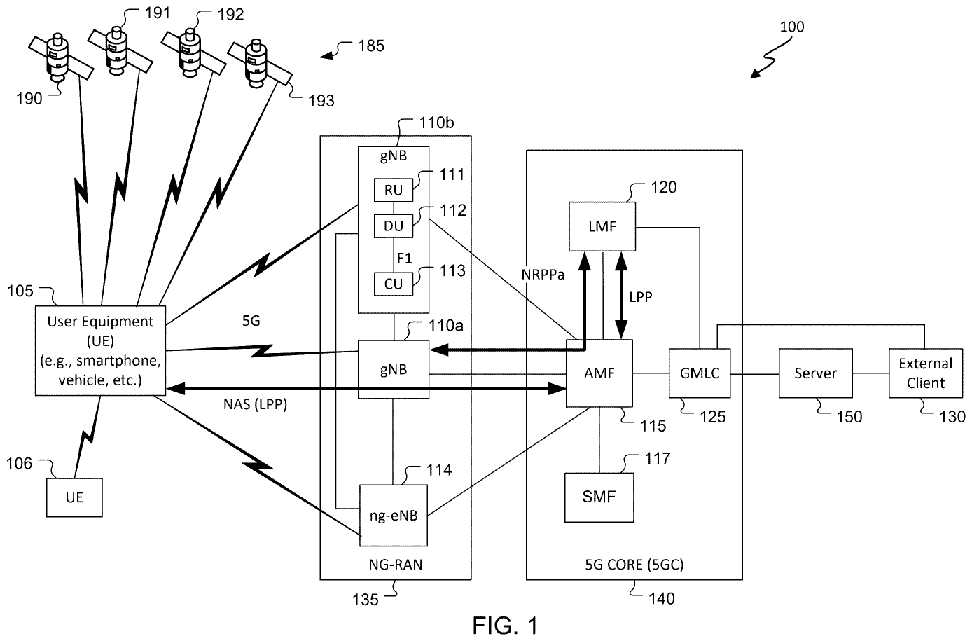

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., a smartphone, an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC has been performed by the Third Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, a future 6G RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of space vehicles (SVs) 190, 191, 192, 193, also referred to as satellites, for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (referred to as gNodeBs or gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media and data sessions with UEs 105 and 106. Base stations such as the gNBs 110a, 110b and/or the ng-eNB 114 may each support a macro cell (e.g., a high-power cellular base station), or a small cell (e.g., a low-power cellular base station). There may also be access points (not shown in FIG. 1) that may each be a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least sometimes using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geodetically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect with one or more others UEs (e.g., the UE 106) via one or more device-to-device (D2D) or peer-to-peer (P2P) links, also referred to as sidelink links. The D2D, P2P and sidelink links may be supported with any appropriate sidelink radio access technology (RAT), such as LTE, LTE Direct (LTE-D), NR, WiFi® Direct (WiFi®-D), Bluetooth®, and so on. One or more of a group of UEs utilizing sidelink communication may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via sidelink communications may utilize a one-to-many (1:M) system in which each UE may transmit to other UEs in the group. A TRP may facilitate scheduling of resources for sidelink communications. In other cases, sidelink communication may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may correspond to (e.g., may be supported by) a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA), Downlink (DL) Time Difference of Arrival (TDOA), Uplink (UL) TDOA, Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push a location estimate of the UE 105 to the server 150. In some embodiments, the server 150 may be absent and the external client 130 may interact directly with the GMLC 125 to request and/or receive a location estimate for the UE 105.

The GMLC 125 may support a location request for the UE 105 received from the external client 130 either directly or via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 either directly or via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NRPPa), which may be defined in 3GPP Technical Specification (TS) 38.455. NRPPa messages can be transferred between the gNB 110a (or the gNB 110 b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 37.355. Here, LPP messages may be transferred between the UE 105 and the LMF 120 via the AMF 115 and the serving gNB 110a, 110b or the serving ng-eNB 114 for the UE 105. For example, LPP messages may be transferred between the LMF 120 and the AMF 115 using service operations based on the Hypertext Transfer Protocol (HTTP), and may be transferred between the AMF 115 and the UE 105 using a 5G Non-Access Stratum (NAS) protocol. The LPP protocol may be used to support positioning of the UE 105 using UE-assisted and/or UE-based position methods such as A-GNSS, RTK, OTDOA, DL-TDOA, AoD and/or E-CID. The NRPPa protocol may be used to support positioning of the UE 105 using network-based position methods such as UL-TDOA or E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP message via the NG-RAN 135 and the 5GC 140.

An LPP message sent from the LMF 120 to the UE 105 may instruct the UE 105 to do any of a variety of things depending on desired functionality. For example, the LPP message could contain an instruction for the UE 105 to obtain measurements for GNSS (or A-GNSS), WLAN, E-CID, OTDOA, DL-TDOA and/or AoD (or some other position method). In the case of E-CID, the LPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use an LPP annex (LPPa) protocol (e.g., defined in 3GPP TS 36.455) in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

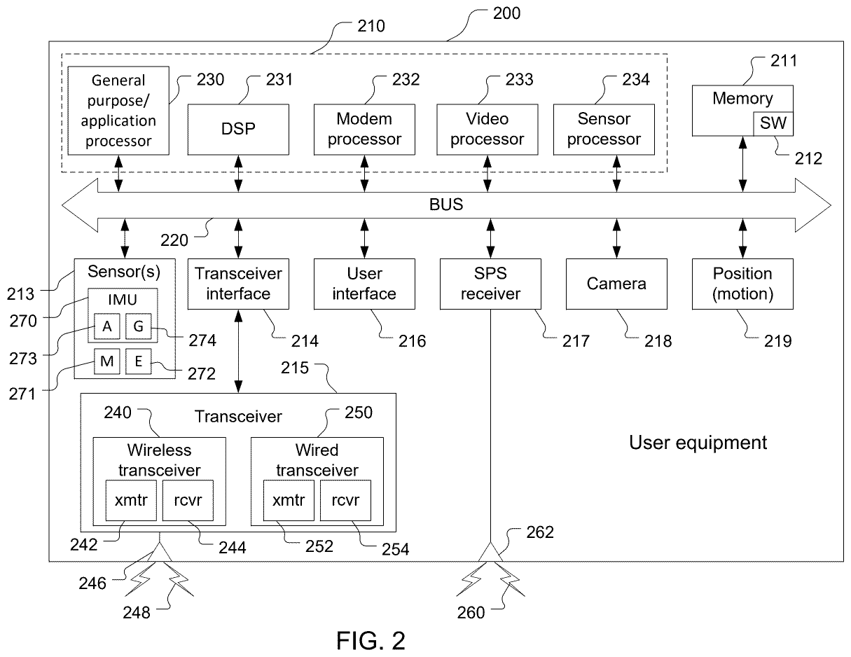

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

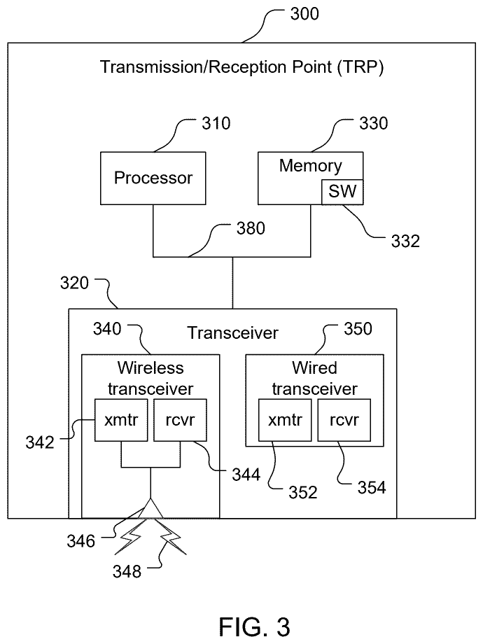

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and/or the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

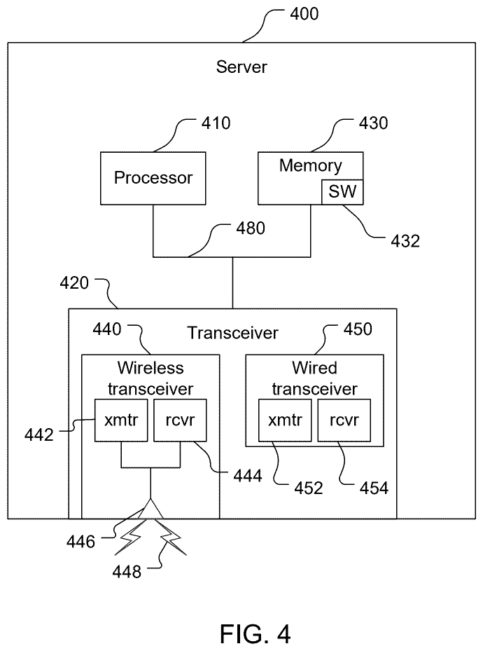

Referring also to FIG. 4, a server 400, of which the LMF 120 and server 150 may be examples, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and/or the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

For terrestrial positioning of a UE (e.g., a UE 105) in cellular networks, techniques such as Observed Time Difference Of Arrival (OTDOA), DL-TDOA and AoD often operate in “UE-assisted” mode in which measurements of reference signals (e.g., PRS, CRS, etc.) transmitted by base stations are taken by the UE and then provided to a location server (e.g., LMF 120). The location server calculates the position of the UE based on the measurements and known locations of the base stations. Because these techniques use the location server to calculate the position of the UE, rather than the UE itself, these positioning techniques may not be frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. This assistance data may be encrypted so that only UEs subscribed to the service can directly obtain the information.

In UE-assisted positioning, the UE sends measurements (e.g., TDOA, Angle of Arrival (AoA), etc.) to the positioning server (e.g., LMF/eSMLC). The positioning server may have base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE may use relevant BSA record information (e.g., locations of gNBs (more broadly base stations)) from the network. The BSA information may be encrypted.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is typically larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques already mentioned above include RTT, multi-RTT, OTDOA, DL-TDOA, UL-TDOA, E-CID, DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA techniques, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the PRS layers individually. This may be referred to as bandwidth aggregation.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

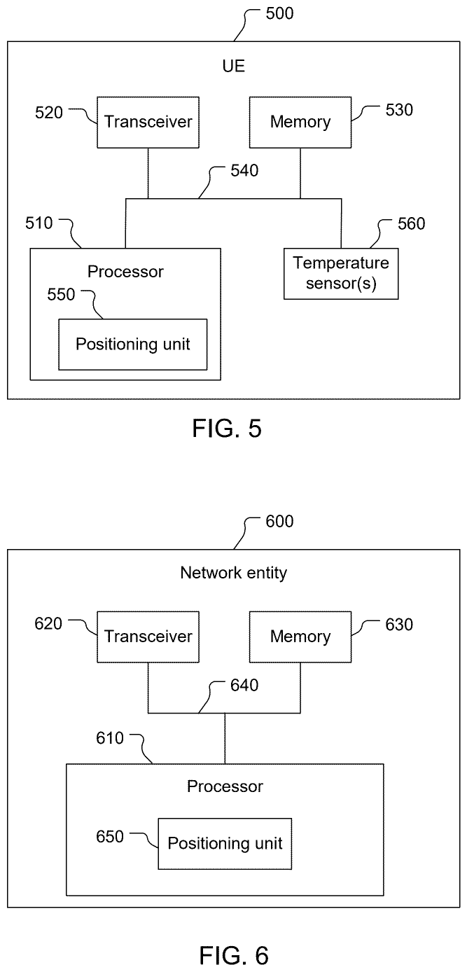

Referring also to FIG. 5, a UE 500 includes a processor 510, a transceiver 520, a memory 530, and one or more temperature sensors 560 communicatively coupled to each other by a bus 540. Even if referred to in the singular, the processor 510 may include one or more processors, the transceiver 520 may include one or more transceivers (e.g., one or more transmitters and/or one or more receivers), and/or the memory 530 may include one or more memories. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a positioning unit 550. The positioning unit 550 may be configured to perform positioning operations (e.g., determine position information (e.g., measurements, pseudoranges, position estimates (using one or more positioning methods), etc.)). The positioning unit 550 may be configured to regulate (e.g., increase or reduce) a positioning function level of service based on one or more temperatures determined by the temperature sensor(s) 560 (e.g., set (e.g., reduce) at least one level of service of at least one operation of the positioning function (e.g., measuring positioning signal(s) and/or estimating UE position) based on one or more temperatures exceeding one or more temperature thresholds). The positioning unit 550 is discussed further below, and the description may refer to the processor 510 generally, or the UE 500 generally, as performing any of the functions of the positioning unit 550, with the UE 500 being configured to perform the function(s).

Referring also to FIG. 6, a network entity 600 includes a processor 610, a transceiver 620, and a memory 630 communicatively coupled to each other by a bus 640. Even if referred to in the singular, the network entity 600 may include one or more network entities, the processor 610 may include one or more processors, the transceiver 620 may include one or more transceivers (e.g., one or more transmitters and/or one or more receivers), and/or the memory 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the network entity 600 may include one or more other components such as any of those shown in FIG. 3 such that the TRP 300 may be an example of the network entity 600. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include a positioning unit 650. The positioning unit 650 may be configured to regulate (e.g., instruct the UE 500 to reduce) a positioning function level of service based on one or more temperatures determined by the temperature sensor(s) 560 (e.g., instruct the UE 500 to reduce at least one level of service of at least one operation of the positioning function based on one or more temperatures exceeding one or more temperature thresholds). The positioning unit 650 is discussed further below, and the description may refer to the processor 610 generally, or the network entity 600 generally, as performing any of the functions of the positioning unit 650, with the network entity 600 being configured to perform the function(s).

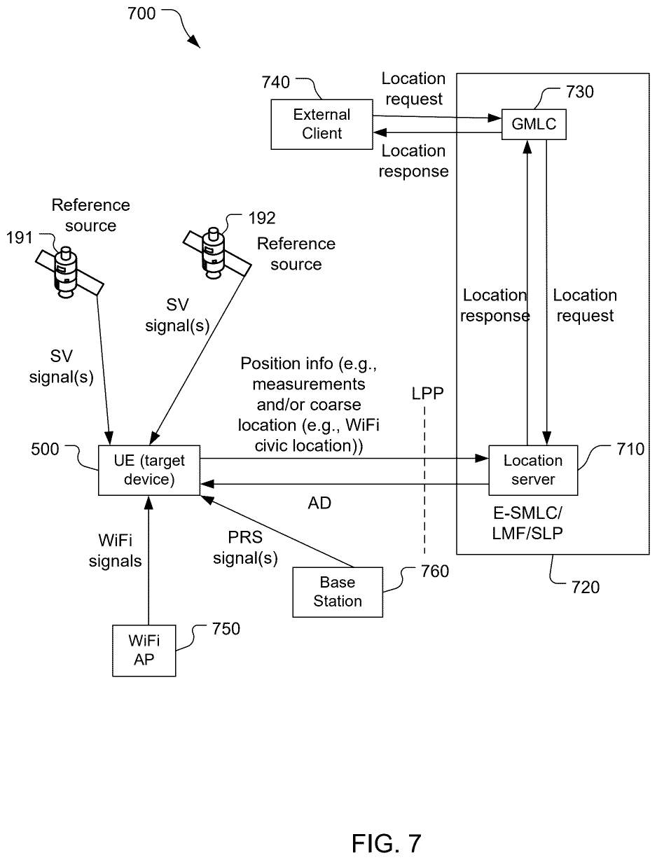

Referring also to FIG. 7, an example positioning environment 700 for determining position estimates of the UE 500 (a target device) includes the UE 500, the SVs 191, 192, a location server 710 (e.g., an E-SMLC, the LMF 120, and/or an SLP), a base station 760 (e.g., a gNB 110 or ng-eNB 114), a GMLC 730 (e.g., the GMLC 125), an external client 740 (e.g., the external client 130), a serving network 720 (e.g., the 5GC 140) and an access point 750 (e.g., a WiFi® access point). The environment 700 may include further entities, e.g., more SVs, e.g., of the same and/or of one or more constellations other than a constellation containing the SVs 191, 192. The external client 740 may issue a location request for the UE 500 to the GMLC 730, e.g., in response to previous interaction with the UE 500 not shown in FIG. 7. The GMLC 730 may send the location request to the location server 710 (e.g., via an AMF not shown in FIG. 7). The location server 710 may communicate with the UE 500 (e.g., via one or more base stations such as the base station 760), e.g., to provide assistance data (AD) to help the UE 500 determine one or more position estimates, and/or to request position information from the UE 500. The UE 500, e.g., the positioning unit 550, may determine a position estimate (e.g., by measuring SV GNSS signals from the SV(s) 191, 192 and/or by measuring terrestrial positioning signals such as PRS transmitted by the base station 760 and/or WiFi signals transmitted by the WiFi AP 750). The UE 500 may transmit position information (e.g., SV signal measurement(s), terrestrial positioning signal measurement(s), coarse position (e.g., a civic position provided via WiFi® by the access point 750)) to the location server 710. The location server 710 may determine a position estimate for the UE 500 from the position information and transmit the position estimate in a location response to GMLC 730 (e.g., directly or via an AMF), which may transmit the position estimate in a location response to the external client 740.

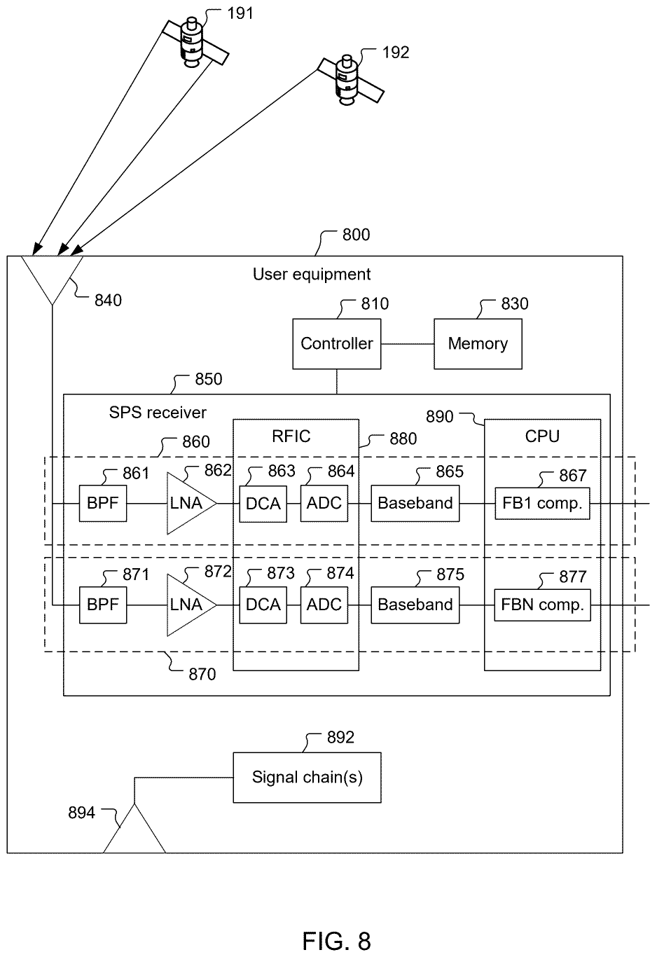

Referring to FIG. 8, with further reference to FIGS. 1-7, a UE 800, which is an example of the UE 500, includes a controller 810, a memory 830, an antenna 840, and an SPS receiver 850 communicatively coupled to each other. The controller 810 may be an example of the processor 510 and the memory 830 may be an example of the memory 530. The controller 810 may be configured to control components of UE 800 including of the SPS receiver 850, e.g., activation status (whether a component (including a portion of a component) is active (e.g., powered or enabled for operation) or inactive (e.g., unpowered or disabled from operation), or how a component operates (e.g., an amount of amplification provided or a frequency of operation)). The controller 810 may be configured to control components of the UE 500 in order to reduce heat produced by components of the UE 500, e.g., to mitigate negative effects of heat on the UE 500 and in particular negative effects regarding position information determination by the UE 500. The antenna 840 is configured to receive satellite signals of different frequency bands, and the antenna 840 may include one or more antennas and/or antenna elements.

The SPS receiver 850 includes multiple receive chains 860, 870 for measuring satellite signals. The satellite signals may have the same frequency or different frequencies, and/or may be in the same range of frequencies, in different but overlapping ranges of frequencies (with one or more shared frequencies), or in separate (non-overlapping) ranges of frequencies (with no shared frequency). The discussion herein refers to the receive chains 860, 870 being for different frequency bands, but this is an example and not limiting of the disclosure, including the claims. The receive chains 860, 870 may be configured to receive and process SV signals of different frequency bands and/or from different SV constellations. Further, while two receive chains are shown in FIG. 8, the UE 800 may include more than two receive chains, e.g., for measuring satellite signals having frequencies in more than two different frequency bands (e.g., different sub-bands). The receive chains 860, 870 may, for example, be configured to measure satellite signals in the L1 and L2/L5 bands, respectively, although this is an example and not limiting of the disclosure as either or both of the receive chains 860, 870 may be configured to measure signals of other frequencies or frequency bands, and/or other receive chains may be included in the UE 800.

The receive chains 860, 870 include respective components for measuring satellite signals. The receive chain 860 includes a BPF 861 (bandpass filter), an LNA 862 (low-noise amplifier), a DCA 863 (Digital Controlled Amplifier for down-conversion, signal conditioning/filtering, and amplification), an ADC 864 (analog-to-digital converter), a baseband block 865, and a computational block 867. The BPF 861 is configured to pass signals of frequencies within a desired frequency band, e.g., the L1 band, with little attenuation, and to significantly attenuate signals of frequencies outside the desired frequency band of the BPF 861. The LNA 862 is configured to amplify signals passed by the BPF 861. The DCA 863 is configured to down convert the analog amplified signals output by the LNA 862 to a baseband frequency, to perform signal conditioning and/or filtering (e.g., anti-aliasing filtering), and amplification in addition to the amplification by the LNA 862. The ADC 864, which here is a portion of an RFIC 880 (Radio Frequency Integrated Circuit), is configured to convert the analog signals output by the DCA 863 into digital signals. The baseband block 865 is configured to perform intense signal processing of correlating the digital signals output by the ADC 864 with respective reference pseudorandom signals (e.g., Gold codes) by integrating the signals (e.g., for 1 ms) and dumping the integrated signals for further processing to determine whether the correlation results have sufficient energy to indicate a true signal. The computational block 867, which here is a portion of a CPU 890 (Central Processing Unit), is configured to perform one or more computations on the signals output by the baseband block 865 to determine one or more satellite signal parameters (e.g., pseudorange, CN₀ (carrier-to-noise-density ratio), Doppler, carrier phase, etc.). The computational block 867 comprises a portion of the CPU 890 for performing computations for the receive chain 860, namely corresponding to signals in the desired frequency band of the BPF 861. Thus, the computational block 867 is shown as being for computation for frequency band 1 (FB1). The CPU 890 may be a portion of the processor 510. The receive chain 870 includes a BPF 871, an LNA 872, a DCA 873, an ADC 874, a baseband block 875, and a computational block 877. The BPF 871 is configured to pass signals of frequencies within a desired frequency band, e.g., the L2/L5 band, with little attenuation, and to significantly attenuate signals of frequencies outside the desired frequency band of the BPF 871. The LNA 872, DCA 873, ADC 874, baseband block 875, and computational block 877 are configured similarly to the LNA 862, DCA 863, ADC 864, baseband block 865, and computational block 867, but configured, as appropriate, for processing signals corresponding to signals of the desired frequency of the BPF 871. Thus, the computational block 877 is shown as being for computation for frequency band N (FBN), as there may be N receive chains, with N being an integer of two or greater.

The UE 800 may include one or more other signal chains 892 in combination with (and communicatively coupled to) one or more antennas 894. For example, the UE 800 may include one or more terrestrial-signal receive chains (e.g., for receiving and processing PRS) and/or one or more terrestrial-signal transmit chains (e.g., for producing and transmitting SRS for positioning). As another example, the UE 800 may include circuitry (e.g., the transceiver interface 214, the transceiver 215, and the antenna 248) for transferring signals other than positioning signals, such as data signals and/or voice call signals.

The receive chains 860, 870 and any other signal chains (e.g., for processing and transferring (e.g., receiving and/or transmitting) terrestrial-network signals (e.g., PRS)) are distinct and may be activated/deactivated independently. The controller 810 may include a PMIC (Power Management Integrated Circuit) configured to control power usage by activating/deactivating components of the SPS receiver 850, activating/deactivating functions (e.g., types of measurements and/or other signal processing) by the CPU 890, and/or activating/deactivating one or more other functions of the UE 800, e.g., support for data transfer by the transceiver 520 and/or support for voice calls by the transceiver 520 and/or one or more other functions (even if unrelated to wireless signal transfer).

The UE 500, of which the UE 800 is an example, may be configured to control functionality of the UE 500 based on one or more temperatures, measured by the temperature sensor(s) 560, relative to one or more temperature thresholds. In the description below, any reference to the UE 500 optionally also includes the functionality described above and shown in FIG. 8 for the UE 800. In one example, the controller 810 may be configured to control the activation status of the receive chains 860, 870 and/or one or more other signal transfer chains and/or other functionality of the UE 500 based on one or more temperatures, measured by the temperature sensor(s) 560, relative to one or more temperature thresholds. Challenging thermal/high-temperature issues are common in mobile devices, such as wearable devices, e.g., when performing operations where many (possibly all) modem components are occupied. Such issues may be more severe during a continuous voice call and/or heavy data use. In some mobile devices, all modem and application activities may be shut down or crash if an internal temperature of the mobile device reaches a threshold temperature such as about 85° C. Shutting down positioning capabilities may have a significant impact, e.g., preventing some applications from properly functioning or functioning at all.

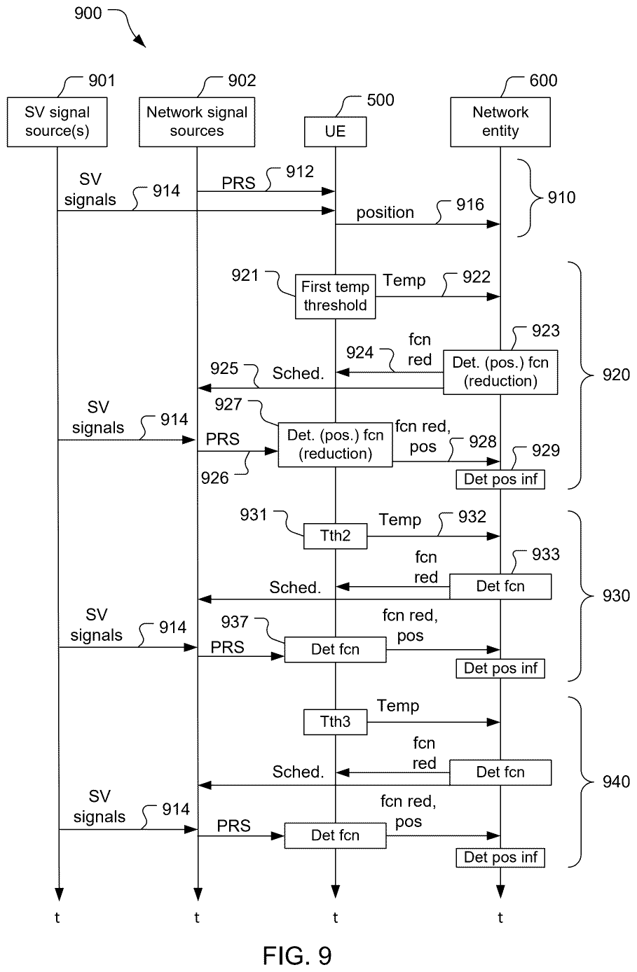

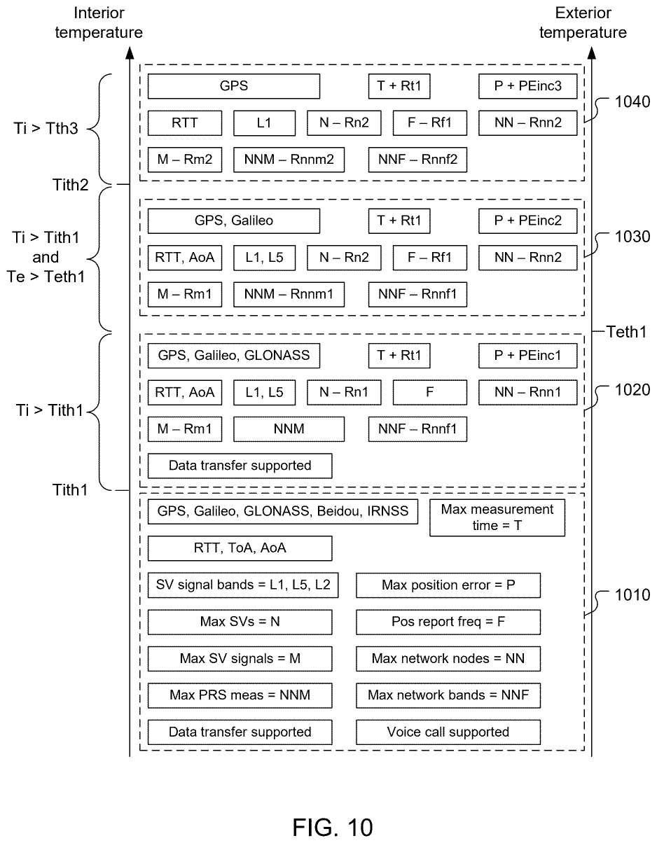

Referring also to FIG. 9, a signal and processing flow 900 for determining a position estimate for the UE 500 in challenging thermal conditions. The flow 900 is an example flow and not limiting. The flow 900 may be altered, e.g., by having one or more messages and/or one or more stages added, removed, rearranged, combined, performed concurrently, and/or having one or more messages and/or one or more stages split into multiple messages and/or stages.

The flow 900 may be used to implement multiple methods of positioning the UE 500 in challenging thermal conditions (e.g., high temperature(s)). For example, the flow 900 may be used for the UE 500 to report (e.g., using LPP signaling) one or more internal temperatures of the UE 500 and/or to report one or more temperatures external to the UE 500. The network entity 600, e.g., the positioning unit 650 of a server, may use the reported temperature(s) to take appropriate action, e.g., to instruct and/or schedule reduced operation of the UE 500 in a challenging thermal condition. This may help to ensure that a position estimate of the UE 500 can be determined before the UE 500 crashes or is unable to enable determination of a position estimate for the UE 500 with sufficient accuracy or maximum latency (e.g., unable to report a position estimate within a required time period or unable to report measurements from which a position estimate can be determined). Also or alternatively, this may help expedite locating a user, e.g., to provide the user with emergency services. As another example, the UE 500, e.g., the positioning unit 550, may use the determined temperature(s) to modify operation of the UE 500 to help prevent excessive heating of the UE 500, e.g., to help ensure that a position estimate of the UE 500 can be determined before the UE 500 crashes or is unable to enable determination of a position estimate for the UE 500 with sufficient accuracy and/or maximum latency, and/or to help expedite provision of emergency services. For example, the UE 500 may modify the multiband SPS capability of the UE 500 (e.g., to reduce which frequency band(s) of SV signals are measured, to reduce from which SV constellations SV signals are measured, and/or to reduce the number of SVs from which SV signals are measured (possibly to zero)), may reduce other positioning methods that can be used (possibly to zero), etc.. Also or alternatively, the UE 500 may limit non-positioning operation, e.g., reducing (possibly eliminating) support for data transfer and/or voice calling. The UE 500 may report operational reduction of the UE 500 to the network entity 600.

The flow 900 is an example, and various modifications are possible. For example, the discussion herein focuses on reduction of positioning operations of the UE 500, with some discussion of reducing non-positioning operation, but other non-positioning operations may also or alternatively be reduced. As another example, the flow 900 may have the UE 500 and the network entity 600 affect operation of the UE 500 in challenging thermal conditions, but in other examples only the UE 500 affects such UE operation and in other examples only the network entity 600 affects such UE operation. As another example, the discussion of FIG. 9 focuses on the use of a single internal temperature (internal to the UE 500) and a single external temperature (external and proximate to the UE 500, e.g., measured by one of the temperature sensor(s) 560), but in other examples more than one internal temperature and/or more than one external temperature may be used, and in other examples one or more internal temperatures but no external temperature may be used, and in other examples one or more external temperatures but no internal temperature may be used.

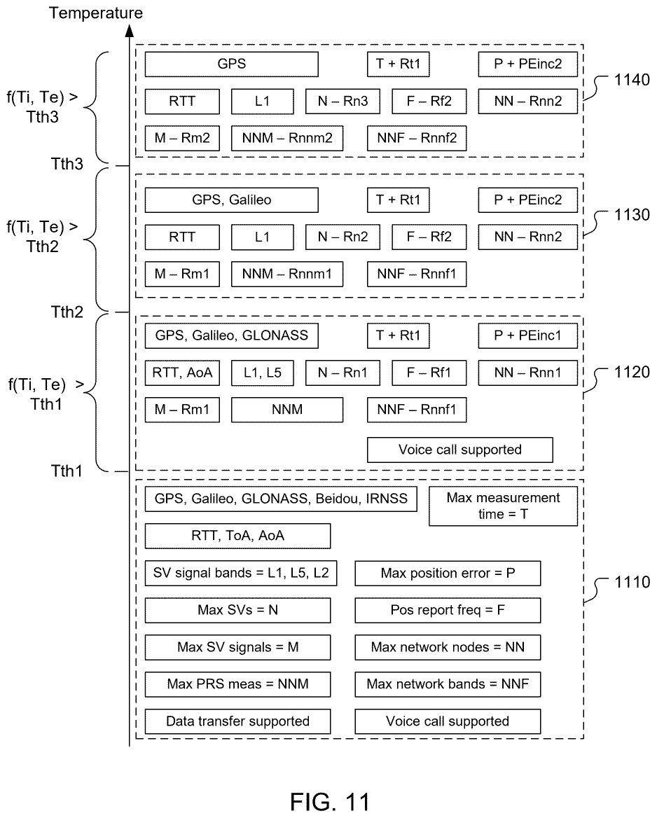

At stage 910, the UE 500 may receive and measure positioning signals 912, 914 and may determine (and possibly report) position information (e.g., one or more position estimates and/or one or more positioning signal measurements) for the UE 500. For example, referring also to FIG. 10 and FIG. 11, during non-challenging thermal conditions, e.g., an internal temperature Tᵢ of the UE 500 being less than a first internal temperature threshold Tᵢₜₕ₁, or a function (formula) of Tᵢ and an external temperature Tₑ (i.e., a value of this function) being less than a first function temperature threshold T_{fth1}, the UE 500 may not inhibit any positioning operation of the UE 500 or any operation at all of the UE 500, i.e., may do nothing different than ordinary operation, e.g., implementing one of the functionality sets 1010, 1110. The function of Tᵢ and Tₑ may be, for example, the internal temperature plus a portion of the external temperature. In the examples shown in FIGS. 10 and 11, under this condition, the following UE functionality may be used: the UE 500 may measure SV signals from the GPS, Galileo, GLONASS, Beidou, and/or IRNSS constellations; the UE 500 may process signals according to the RTT, ToA (e.g., for SV signals), and AoA positioning methods; a maximum measurement time may be set to a value of T seconds; SV signals in frequency bands L1, L5, and L2 may be measured; a maximum position error may be set to P meters; a maximum number of SVs from which SV signals may be measured may be set to N; a maximum number of SV signals that may be measured may be set to M; a frequency of reporting a position estimate for the UE 500 may be set to F reports/second; a maximum number of network nodes from which terrestrial positioning signals (e.g., PRS and/or WiFi signals) may be measured may be set to NN; a maximum number of terrestrial positioning signals (e.g., PRS and/or WiFi signals) that may be measured may be set to NNM; a maximum number of frequency bands of terrestrial positioning signals that may be measured may be set to NNF; data transfer is supported; and voice calling is supported. The UE 500, e.g., the positioning unit 550, may measure positioning signals and possibly determine a position estimate for the UE 500 (e.g., using SV signals 914 from SV signal sources 901 and/or terrestrial positioning signals 912 from terrestrial network signal sources 902, and using one or more positioning methods). The UE 500 may transmit position information (e.g., the positioning signal measurements and/or the position estimate) in a position message 916 to the network entity 600, e.g., an LMF.

At stage 920, a first temperature threshold is reached, and functionality of the UE 500 is reduced, e.g., to inhibit further heating of, and possibly enable cooling of, the UE 500, e.g., to inhibit failure to obtain an acceptably-accurate position estimate for the UE 500 within an acceptable amount of time. For example, the UE 500 may monitor the internal temperature Tᵢ of the UE 500, e.g., proximate to one or more components for use in obtaining a position estimate (e.g., for measuring positioning signals and/or processing measurements of positioning signals). The UE 500 may also or alternatively monitor the external temperature Tₑ outside (e.g., immediately outside) of the UE 500. At sub-stage 921, the UE 500 may determine that the internal temperature Tᵢ exceeds the first internal temperature threshold Tᵢₜₕ₁, and may transmit a temperature message 922 to the network entity 600 indicating that the Tᵢ exceeds the first internal temperature threshold Tᵢₜₕ₁. Also or alternatively, the UE 500 may determine that a function of the internal temperature Tᵢ and the external temperature Tₑ exceeds a first function temperature threshold T_{fth1}, and may transmit the temperature message 922 to the network entity 600 indicating that the function of Tᵢ and Tₑ exceeds the first temperature threshold Tₜₕ₁. The temperature message 922 may be transmitted as an information element (IE), e.g., called Device_Temperature, and may indicate that the internal temperature Tᵢ exceeds the first internal temperature threshold Tᵢₜₕ₁, and/or may indicate that the external temperature Tₑ exceeds a first external temperature threshold Tₑₜₕ₁, and/or may indicate the internal temperature Tᵢ and/or the external temperature Tₑ in degrees Fahrenheit and/or in degrees Celsius.

At sub-stage 923, if the temperature message 922 was received from the UE 500, the network entity 600 may determine positioning functionality, e.g., a positioning functionality reduction, for the UE 500. The network entity 600 may determine one or more levels of operation, e.g., setting the level, reducing the level from a present level, or increasing the level from a present level. For example, the network entity 600 may determine a reduction of a level of service of a positioning function, with the positioning function including positioning operations including measuring at least one wireless positioning signal received by the UE 500 and estimating a position of the UE 500. Reducing the level of service of the positioning function may include reducing (or eliminating) at least one level of service of at least one of the positioning operations of the positioning function based on at least one temperature (e.g., the internal temperature Tᵢ, or a function of the internal temperature Tᵢ and the external temperature Tₑ) exceeding at least one first temperature threshold. The network entity 600 may determine reduction in general UE functionality in addition to, or instead of, positioning functionality. The network entity 600 may determine function reduction(s) based on the thermal condition(s), e.g., the internal temperature Tᵢ and expected heat saving for each function reduction, or based on the internal temperature Tᵢ and/or the external temperature Tₑ and corresponding stored function reduction (e.g., functionality sets stored, e.g., in a look-up table (LUT)). The network entity 600 may determine one or more reductions in functionality and may transmit a function reduction message 924 to the UE 500 indicating the function reduction(s) to implement. An indication from the network entity 600 of a reduction in functionality may be an instruction to reduce functionality or an indication of acceptable reduction in functionality that the UE 500 may or may not implement. The reduction in functionality may include a reduction in quality of service (QoS) (e.g., lower position information accuracy and/or shorter time for the UE 500 to determine and report a location fix), a reduction in a total number of positioning signal measurements, and/or a reduction in positioning signal measurement frequency, etc. The reduction in functionality may include, for example, reducing a positioning signal measurement accuracy, reducing a positioning signal measurement frequency, reducing a position estimation accuracy, increasing a time allowed for the at least one of the positioning operations, increasing a time allowed for the positioning function, reducing a number of positioning signals measured by the mobile device, and/or reducing a number of types of positioning signals measured by the mobile device, etc. The reduction in functionality may include, for example, eliminating one or more positioning operations entirely, such as eliminating all GNSS measurements, eliminating all WiFi® measurements, and/or eliminating use of bandwidth aggregation when measuring PRS signals. Even if one or more positioning operations (e.g., GNSS measurements) is/are eliminated, one or more other operations (e.g., positioning using WiFi® measurements or PRS measurements) may continue to be performed.

Also or alternatively at sub-stage 923, the network entity 600 may determine a reduction in terrestrial positioning signal scheduling (e.g., reduction in scheduled transmission (and thus measurement) of resource elements in terms of frequencies (e.g., subcarriers) and/or symbols scheduled), and may transmit a scheduling message 925 to each of one or more network signal sources 902 indicating one or more terrestrial network positioning signal scheduling parameters (e.g., comb number, symbol offset, frequency range, repetition factor, etc.). For example, the network entity 600 may reduce a number of measurements scheduled for the UE 500. As another example, the network entity 600 may schedule signaling for the UE 500 to allow more time to obtain position information (e.g., scheduling fewer measurements per second than an initial rate of measurements). The network signal sources 902 may determine positioning signal schedules based on the terrestrial network positioning signal scheduling parameters in the scheduling message 925, and transmit positioning signals 926 (e.g., PRS or WiFi signals) to the UE 500 according to the respective schedule.

At sub-stage 927, based on the first temperature threshold having been reached, the UE 500 may determine function reduction for the UE 500. The UE 500 may determine reduction in positioning functionality and/or non-positioning functionality of the UE 500. The UE 500 may determine functionality reduction similar to the network entity 600, or may determine the functionality reduction from the message 924. Various temperature thresholds may be used as the first temperature threshold, e.g., 55° C., 60° C., or 65° C. (or another temperature) for the first temperature threshold. The UE 500 may modify the functionality (e.g., the multiband SPS capability) of the UE 500 and report to the network entity 600, in a function reduction/position information message 928, the reduced functionality implemented by the UE 500 and position information (e.g., one or more positioning signal measurements and/or one or more position estimates). For example, the message 928 may indicate from which SVs, which SV constellation(s), and/or which SV signal band(s) the UE 500 is presently supporting SV signal measurements. As another example, the message 928 may indicate SVs with which the UE 500 has or is likely to have LOS (Line of Sight), e.g., based on a coarse location of the UE 500 (e.g., based on E-CID and/or location of an access point within short-range wireless protocol (e.g., WiFi®) range of the UE 500) and ephemeris and/or almanac information for the SV signal sources 901. As another example, the message 928 may indicate the preferred positioning method(s) for the UE 500 (e.g., WWAN cell-based positioning, SPS-based positioning, and/or DBH (device-based hybrid) positioning). The UE 500 may determine and indicate that the UE 500 is not supporting SPS-based positioning, e.g., because SPS-based positioning (e.g., SV signal decoding and tracking) consumes significant power and thus produces significant heat. The UE 500 may prioritize one or more non-3GPP-based solutions such as DBH, Android®, Google®, and/or an LPP Extensions (LPPe) protocol defined by the Open Mobile Alliance (OMA), etc. and indicate the prioritized solution(s) to the network entity 600.

One or more of various operations may be altered in order to reduce UE functionality. For example, as shown in FIG. 10, with the internal temperature Tᵢ exceeding the first internal temperature threshold Tᵢₜₕ₁ (but without another temperature threshold, if any, having been reached), to implement a reduced functionality set 1020 the following UE functionality may be altered: the UE 500 may measure SV signals from the GPS, Galileo, and GLONASS constellations (but not the Beidou or IRNSS constellations); the UE 500 may process signals according to the RTT and AoA positioning methods (but not ToA); the maximum measurement time may be increased to a value of T+Rₜ₁ seconds; SV signals in frequency bands L1 and L5 (but not L2) may be measured; the maximum position error may be increased to P+PE_{inc1} meters; the maximum number of SVs from which SV signals may be measured may be reduced to N—Rₙ₁; the maximum number of SV signals that may be measured may be reduced to M—Rₘ₁; the maximum number of network nodes from which terrestrial positioning signals may be measured may be reduced to NN—Rₙₙ₁; the maximum number of frequency bands of terrestrial positioning signals that may be measured may be reduced to NNF—R_{nnf1}; and voice calling support may be eliminated. Some functionality (in this example, data transfer support, the frequency (F) of reporting a position estimate for the UE 500, and the maximum number (NNM) of terrestrial positioning signals that may be measured) of the UE 500 may not change based on the first internal temperature threshold Tᵢₜₕ₁ being exceeded. As another example, as shown in FIG. 11, with the function of the internal temperature Tᵢ and the external temperature Tₑ exceeding the first temperature threshold Tₜₕ₁ (but without another temperature threshold, if any, having been reached), to implement a reduced functionality set 1120 the following UE functionality may be altered: the UE 500 may measure SV signals from the GPS, Galileo, and GLONASS constellations (but not the Beidou or IRNSS constellations); the UE 500 may process signals according to the RTT and AoA positioning methods (but not ToA); the maximum measurement time may be increased to a value of T+Rₜ₁ seconds; SV signals in frequency bands L1 and L5 (but not L2) may be measured; the maximum position error may be increased to P+PE_{inc1} meters; the maximum number of SVs from which SV signals may be measured may be reduced to N—Rₙ₁; the frequency of reporting a position estimate for the UE 500 may be reduced to F—R_{f1}; the maximum number of SV signals that may be measured may be reduced to M—Rₘ₁; the maximum number of network nodes from which terrestrial positioning signals may be measured may be reduced to NN—Rₙₙ₁; the maximum number of frequency bands of terrestrial positioning signals that may be measured may be reduced to NNF—R_{nnf1}; and data transfer support may be eliminated. Reduction of functionality may include the elimination (e.g., reduction to zero) of one or more operations altogether.

At sub-stage 927, the UE 500 may determine position information. The UE 500 may determine one or more measurements of one or more positioning signals (e.g., PRS, SV signals, etc.) using the selected positioning functionality. The UE 500 may determine one or more position estimates for the UE 500 based on the positioning signal measurement(s).

At sub-stage 929, the network entity 600 may determine position information. For example, the network entity 600 may determine one or more position estimates based on one or more positioning signal measurements provided in the message 928, and/or may read one or more position estimates provided in the message 928.

Stages 930 and 940 are similar to stage 910, but provide for increased reduction of UE functionality based on one or more increasing thermal conditions associated with the UE 500. For example, functionality may be reduced in a prioritized order, based on one or more increasing temperatures, in order to try to enable determination of satisfactory position estimates of the UE 500 under more and more challenging thermal conditions. The prioritized order may, for example, eliminate use of one SPS constellation (e.g., IRNSS) before elimination of use of another SPS constellation (e.g., GPS). As another example, a position determined using one constellation may be de-weighted and combined with a position determined using another constellation. The prioritized order may be different based on a location of the UE 500, e.g., based on a country in which the UE 500 is location. For example, if the UE 500 is in the United States, then use of the IRNSS and/or Beidou constellation(s) may be eliminated (or position determined using IRNSS and/or Beidou constellation(s) de-weighted) before elimination (if ever) of the use of the GPS constellation, but if the UE 500 is in India, then use of the GPS and/or Beidou constellations may be eliminated (or position determined using GPS and/or Beidou constellation(s) de-weighted) before elimination of the use of the IRNSS constellation, and if the UE 500 is in China, then use of the GPS and/or IRNSS constellations may be eliminated (or position determined using GPS and/or IRNSS constellation(s) de-weighted) before elimination of the use of the Beidou constellation. As another example, measuring SV signals in the L2 band may be eliminated before elimination (if ever) of measuring SV signals in the L5 band or the L1 band. The prioritized order may include prioritized function reduction and prioritized reduction within one or more of the function reductions. For example, a prioritized function reduction may be: first, reduce constellations from which to measure SV signals; second, reduce the frequency bands of SV signals measured; third, reduce the number of SVs from which signals are measured; and fourth, increase a positioning signal measurement time and/or reduce a number of positioning signal measurements. Further, constellations may be eliminated from use in a prioritized order, e.g., eliminate IRNSS first, Beidou second, GLONASS third, Galileo fourth, and GPS (if ever eliminated) fifth. This order may depend on the location of the UE 500 (e.g., with the stated order above being based on the UE 500 being in North America). Also or alternatively, the frequency bands of signals measured may be eliminated in a prioritized order, e.g., first L2, then L5, then L1 (if ever eliminated). Still other functionality may be reduced in a prioritized order.

For stage 930, with a second temperature threshold Tₜₕ₂ exceeded (as determined by the UE 500 at sub-stage 931, or as determined by the network entity 600 based on temperature(s) reported by the UE 500 in a message 932), a further reduced functionality set 1030 may be instructed/scheduled by the network entity 600 at sub-stage 933 and/or determined by the UE 500 at sub-stage 937. For the example shown in FIG. 10, the second temperature threshold may be the external temperature Tₑ exceeding a first external temperature threshold Tₑₜₕ₁ while the internal temperature Tᵢ exceeds the first internal temperature threshold Tᵢₜₕ₁. For the example shown in FIG. 10, with the second temperature threshold exceeded (but without a further temperature threshold, if any, having been reached), the following further UE functionality reductions may be implemented: the UE 500 may measure SV signals from the GPS and Galileo constellations (but not the GLONASS, Beidou, or IRNSS constellations); the maximum position error may be increased to P+PE_{inc2} meters (where PE_{inc2}>PE_{inc1}); the maximum number of SVs from which SV signals may be measured may be reduced to N—Rₙ₂ (where Rₙ₂>Rₙ₁); the frequency of reporting a position estimate for the UE 500 may be reduced to F-Rf1; the maximum number of network nodes from which terrestrial positioning signals may be measured may be reduced to NN—Rₙₙ₂ (where Rₙₙ₂>Rₙₙ₁); the maximum number of terrestrial positioning signals that may be measured may be reduced to NNM—Rₙₙₘ₁; and data transfer support may be eliminated. Some functionality may not be further reduced from exceeding the first temperature threshold based on exceeding the second temperature threshold. Similarly, for the example shown in FIG. 11, a further-reduced functionality set 1130 (reduced more than the functionality set 1120 (corresponding to the first temperature threshold being exceeded but the second temperature threshold not exceeded) may be implemented based on the function of the internal temperature Tᵢ and the external temperature Tₑ exceeding the second temperature threshold.

For stage 940, with a third temperature threshold Tₜₕ₃ exceeded, a still further reduced functionality set may be instructed/scheduled by the network entity 600 and/or determined by the UE 500. For example, a still-further-reduced functionality set 1040 may be implemented based on the internal temperature Tᵢ exceeding a second internal temperature threshold Tᵢₜₕ₂ while the external temperature Tₑ exceeds the first external temperature threshold Tₑₜₕ₁. As another example, a still-further-reduced functionality set 1140 may be implemented based on the function of the internal temperature Tᵢ and the external temperature Tₑ exceeding the third temperature threshold Tₜₕ₃. For example, the still-further-reduced functionality set 1140 may include one or more of: (i) reducing a number of positioning signal measurements (e.g., reducing a total number of positioning signal measurements, or reducing a number of positioning signal measurements of a particular type or types, such as GPS code phase measurements for L1 signals or L1 plus L5 signals); (ii) reducing a number of types of positioning signal measurements (e.g., eliminating GNSS carrier phase measurements but continuing to perform GNSS code phase measurements); and (iii) eliminating one or more positioning operations (e.g., eliminating, and thus not performing, any GNSS positioning measurements and/or any WiFi positioning measurements).

The various combinations of temperature(s), temperatures threshold(s), and corresponding functionality set(s) may be stored in the memory 530 and/or the memory 630, e.g., in a respective look-up table (LUT). The network entity 600 and/or the UE 500 may determine the functionality set to implement by finding the corresponding thermal condition (e.g., temperature or temperature combination or temperature function value) in the LUT. While the discussion focused on implementing the functionality set 1010 and reducing functionality, moving to the sets 1020, 1030, 1040 based on temperature, other implementations may be used. For example, any of the functionality sets 1010, 1020, 1030, 1040 may be selected directly, without first implementing another functionality set. Alternatively, the functionality set 1040 may be implemented initially, and functionality added (e.g., moving to the sets 1030, 1020, 1010) as long as the temperature is acceptable (e.g., below one or more respective thresholds).

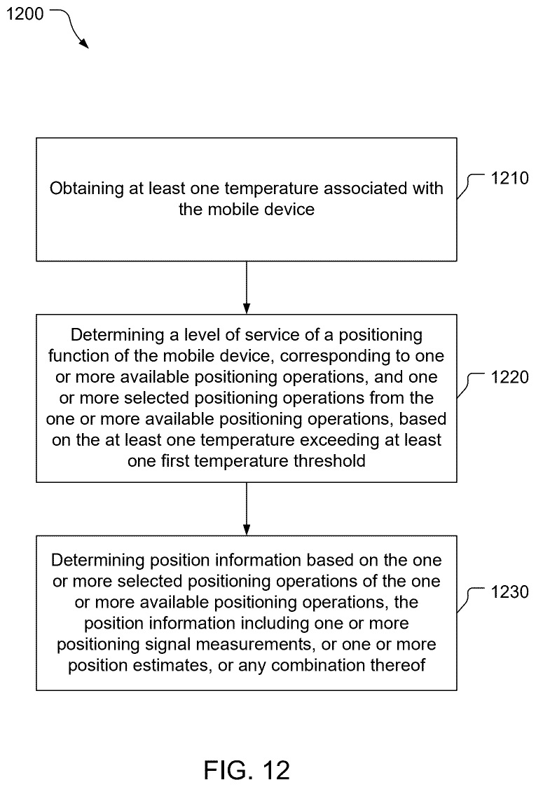

Referring to FIG. 12, with further reference to FIGS. 1-11, a method 1200 for providing positioning service for a mobile device includes the stages shown. The method 1200 is, however, an example only and not limiting. The method 1200 may be altered, e.g., by having one or more stages added, removed, rearranged, combined, performed concurrently, and/or by having one or more single stages split into multiple stages. The method 1200 may be performed by the mobile device (e.g., a UE 105, UE 500 or UE 800) or by a network entity or server (e.g., the server 400, the network entity 600, the server 150 or the LMF 120).

At stage 1210, the method 1200 includes obtaining at least one temperature associated with the mobile device. For example, at stage 920 the UE 500, e.g., one or more of the temperature sensor(s) 560, may measure one or more internal temperatures of the UE 500 and/or one or more temperatures external to the UE 500. The temperature sensor(s) 560, possibly in combination with the processor 510 (possibly in combination with the memory 530) may comprise means for obtaining the at least one temperature associated with the mobile device. As another example, at stage 920, the network entity 600 may receive one or more indications of one or more temperatures measured by the UE 500. The processor 610, possibly in combination with the memory 630, in combination with the transceiver 620 (e.g., the wired receiver 454 and/or the wireless receiver 444 and the antenna 446) may comprise means for obtaining the at least one temperature associated with the mobile device.

At stage 1220, the method 1200 includes determining a level of service of a positioning function of the mobile device, corresponding to one or more available positioning operations, and one or more selected positioning operations from the one or more available positioning operations, based on the at least one temperature exceeding at least one first temperature threshold. For example, at stage 920, in particular the sub-stage 927, the UE 500 may determine and implement a selected positioning level of service (and possibly other functionality) of the UE 500. The selected positioning level of service may be directly selected, or selected as a change from a presently-implemented level of service. For example, the UE 500 may implement the functionality set 1020 based on the internal temperature Tᵢ of the UE 500 exceeding the first internal temperature threshold Tᵢₜₕ₁ or the functionality set 1120 based on the function of the internal temperature Tᵢ and the external temperature Tₑ exceeding the first temperature threshold Tₜₕ₁. Implementation of the functionality set 1020 or the functionality set 1120 may be selected without regard to a present functionality, or may be a reduction in functionality, e.g., as a change from the set 1010 or the set 1110. The selected positioning operation(s) may be determined explicitly or implicitly (e.g., by determining the positioning function service level and the positioning operation(s) being predetermined for the selected positioning function service level). The processor 510 (possibly in combination with the memory 530) possibly in combination with the transceiver (e.g., the wireless receiver 242 and the antenna 246), e.g., the controller 810 (possibly in combination with one or more of the receive chains 860, 870 and/or one or more of the signal chain(s) 892 (e.g., for processing terrestrial positioning signals)), may comprise means for reducing the level of service of the positioning function. As another example, at sub-stage 923, the network entity 600 may determine and instruct a service level reduction to the UE 500. The processor 610, possibly in combination with the memory 630, in combination with the transceiver 620 (e.g., the wired transmitter 452 and/or the wireless transmitter 442 and the antenna 446) may comprise means for reducing the level of service of the positioning function.

At stage 1230, the method 1200 includes determining position information based on the one or more selected positioning operations of the one or more available positioning operations, the position information including one or more positioning signal measurements, or one or more position estimates, or any combination thereof. For example, at sub-stage 927, the UE 500 may determine positioning signal measurement(s) and may determine one or more position estimates. The processor 510 (possibly in combination with the memory 530) possibly in combination with the transceiver (e.g., the wireless receiver 242 and the antenna 246) may comprise means for determining position information. As another example, at sub-stage 929 the network entity 600 may determine position information from information provided in the message 928. The processor 610, possibly in combination with the memory 630, in combination with the transceiver 620 (e.g., the wired transmitter 452 and/or the wireless transmitter 442 and the antenna 446) may comprise means for determining position information.

Implementations of the method 1200 may include one or more of the following features. In an example implementation, determining the one or more selected positioning operations comprises at least one of: determining (e.g., reducing) a positioning signal measurement accuracy; determining (e.g., reducing) a positioning signal measurement frequency; determining (e.g., reducing) a position estimation accuracy; determining (e.g., increasing) a time allowed for the one or more selected positioning operations; determining (e.g., increasing) a time allowed for the positioning function; determining (e.g., reducing) a number of positioning signals measured by the mobile device; determining (e.g., reducing) a number of positioning signal measurements by the mobile device; determining (e.g., reducing) a number of types of positioning signal measurements by the mobile device; determining (e.g., reducing) a number of types of positioning signals measured by the mobile device; and determining to omit at least one of the one or more available positioning operations from the one or more selected positioning operations. In a further example implementation, determining the one or more selected positioning operations includes omitting (e.g., eliminating) use of at least one of L2-band satellite signals and L5-band satellite signals from the one or more selected positioning operations. For example, the functionality sets 1020, 1030 omit use of L2-band SPS signals (e.g., eliminate use of L2-band SPS signals relative to the functionality set 1010), and the functionality set 1040 omits use of L5-band SPS signals (e.g., eliminates use of L5-band SPS signals relative to the functionality sets 1010, 1020, 1030). As another example, the functionality sets 1120 omits use of L2-band SPS signals (e.g., eliminates use of L2-band SPS signals relative to the functionality set 1110), and the functionality sets 1130, 1140 omit use of L5-band SPS signals (e.g., eliminate use of L5-band SPS signals relative to the functionality sets 1110, 1120). In another further example implementation, determining the one or more selected positioning operations includes determining (e.g., reducing) a number of satellites from which positioning signals are measured by the mobile device. For example, each of the functionality sets 1020, 1120 has a reduced number of SVs (N Rn1), compared to the functionality sets 1010, 1110, respectively, from which SV signals may be measured. In another further example implementation, determining the one or more selected positioning operations of the positioning function includes increasing a satellite signal measurement time to up to one minute. For example, a value of the revised time T+Rₜ₁ may be up to 60 seconds.

Also or alternatively, implementations of the method 1200 may include one or more of the following features. In an example implementation, determining the level of service of the positioning function comprises reducing the level of service of the positioning function to different levels of service in a prioritized order of level of service, comprising: determining the level of service of the positioning function to be a first level based on the at least one temperature exceeding at least one first temperature threshold; and determining the level of service of the positioning function to be a second level based on the at least one temperature exceeding at least one second temperature threshold that is higher than the at least one first temperature threshold; wherein the second level corresponds to reduced positioning functionality relative to the first level. For example, at stages 920, 930, 940, different functionality sets (e.g., the sets 1020, 1030, 1040 or the sets 1120, 1130, 1140, or other sets) may be implemented in order (e.g., based on temperature thresholds corresponding to increasing thermal condition levels). The prioritized order of level of service includes a greater level of service reduction corresponding to the at least one temperature exceeding at least one second temperature threshold that is higher than the at least one first temperature threshold. For example, each of the functionality sets 1030, 1130 provides for less functionality than the functionality sets 1020, 1120, respectively. In a further example implementation, determining the level of service of the positioning function comprises: reducing a level of service of at least one of the one or more selected positioning operations to a third level based on the at least one temperature exceeding the at least one first temperature threshold; and based on the at least one temperature exceeding the at least one second temperature threshold, at least one of: reducing a level of service of at least another one of the one or more selected positioning operations; and reducing the level of service of the at least one of the one or more selected positioning operations to a fourth level, wherein the fourth level corresponds to reduced positioning functionality relative to the third level. For example, the functionality sets 1030, 1130 have reduced functionality of at least one operation not having reduced functionality in the functionality sets 1020, 1120, respectively, and/or an increased functionality reduction of at least one operation that has reduced functionality in the functionality sets 1020, 1120, respectively. For example, the set 1030 has reduced frequency of reporting a position estimate for the UE 500 that the set 1020 does not. As another example, the set 1030 has greater acceptable positioning error than the set 1020. In another further example implementation, the reduced positioning functionality includes at least one of: a reduced positioning signal measurement accuracy; a reduced positioning signal measurement frequency; a reduced position estimation accuracy; increased time allowed for the one or more selected positioning operations; increased time allowed for the positioning function; a reduced number of positioning signals measured by the mobile device; a reduced number of positioning signal measurements by the mobile device; a reduced number of types of positioning signal measurements by the mobile device; a reduced number of types of positioning signals measured by the mobile device; and omission of at least one of the one or more available positioning operations from the one or more selected positioning operations. In another further example implementation, the prioritized order of level of service depends on a location of the mobile device. For example, the order of reduction in level of service (e.g., the frequency band(s) of SV signals measured) may depend on a location of the UE 500 (e.g., a country in which the UE 500 is located). As another example, a prioritized order may be constellation reduction, frequency band reduction, satellite quantity reduction, then increased measurement time in one location (e.g., country or continent), but a different order (e.g., frequency band reduction, satellite quantity reduction, constellation reduction, then increased measurement time) in a different location. In another further example implementation, reducing the level of service of the positioning function to different levels of service in the prioritized order of level of service comprises eliminating use of signals from satellite constellations according to a prioritized constellation order. In a further example implementation, the prioritized constellation order comprises, in order of priority from lower priority of signal use to higher priority of signal use, IRNSS (Indian Regional Navigational Satellite System) signals, Beidou signals, GLONASS signals, and Galileo signals. The order of elimination of constellations from which SV signals are measured may depend on a location of the UE 500 (e.g., a country or continent in which the UE 500 is located). For example, the order of IRNSS, Beidou, GLONASS, Galileo may correspond to North America but not Europe or India.

Also or alternatively, implementations of the method 1200 may include one or more of the following features. In an example implementation, the at least one temperature includes at least one of an internal temperature of the mobile device and an environmental temperature external to the mobile device. In a further example implementation, determining the level of service of the positioning function of the mobile device comprises determining the level of service of the positioning function of the mobile device based on a function of the internal temperature and the environmental temperature exceeding the at least one first temperature threshold. In another example implementation, which of the one or more available positioning operations comprise the one or more selected positioning operations depends on a location of the mobile device. For example, depending on the location of the UE 500, functionality selection (e.g., reduction) of different operations may be implemented, e.g., constellation reduction in one country but not another, or frequency band reduction in one country but not another. In another example implementation, the method 1200 is performed by the mobile device and includes transmitting, from the mobile device to a network entity, an indication of the level of service of the positioning function to be implemented by the mobile device. For example, at sub-stage 927 the UE 500 may transmit the function reduction/position information message 928 to the network entity 600 indicating what functionality reduction the UE 500 will implement (e.g., which functionality set the UE 500 will implement). The processor 510, possibly in combination with the memory 530, in combination with the transceiver 520 (e.g., the wireless transmitter 242 and the antenna 246) may comprise means for transmitting the indication of reduction of the level of service of the positioning function. In another example implementation, the method 1200 is performed by the mobile device and includes transmitting, from the mobile device to a network entity, an indication of a preferred positioning method of the mobile device based on reduction of the level of service of the positioning function. For example, at sub-stage 927 the UE 500 may transmit the function reduction/position information message 928 to the network entity 600 indicating one or more preferred positioning methods, e.g., such that the network entity 600 may schedule positioning signaling accordingly. The processor 510, possibly in combination with the memory 530, in combination with the transceiver 520 (e.g., the wireless transmitter 242 and the antenna 246) may comprise means for transmitting the indication of a preferred positioning method. In another example implementation, the method 1200 is performed by a network entity and includes transmitting, from the network entity to the mobile device, an instruction for the mobile device to reduce the level of service of the positioning function. For example, at sub-stage 923 the network entity 600 may transmit the function reduction message 924 to the UE 500 indicating for the UE 500 to reduce a positioning function. The processor 610, possibly in combination with the memory 630, in combination with the transceiver 620 (e.g., the wired transmitter 452 and/or the wireless transmitter 442 and the antenna 446) may comprise means for transmitting the instruction for the mobile device to reduce the level of service of the positioning function. In another example implementation, the method 1200 is performed by a network entity and includes reducing, by the network entity, a number of positioning signal measurements scheduled for the mobile device. For example, at sub-stage 923 the network entity 600 may transmit the scheduling message 925 to one or more of the network signal sources 902 to cause the network signal source(s) to schedule fewer positioning signals than presently scheduled. The processor 610, possibly in combination with the memory 630, in combination with the transceiver 620 (e.g., the wired transmitter 452 and/or the wireless transmitter 442 and the antenna 446) may comprise means for reducing a number of positioning signal measurements scheduled for the mobile device. In another example implementation, the method 1200 is performed by a network entity and includes reducing, by the network entity, a frequency of scheduled location reporting by the mobile device. For example, at sub-stage 923 the network entity 600 may transmit the function reduction message 924 to the UE 500 indicating for the UE 500 to reduce a frequency of reporting position estimates for the UE 500. The processor 610, possibly in combination with the memory 630, in combination with the transceiver 620 (e.g., the wired transmitter 452 and/or the wireless transmitter 442 and the antenna 446) may comprise means for reducing a frequency of scheduled location reporting by the mobile device.

### Implementation Examples

Implementation examples are provided in the following numbered clauses.

Clause 1. A method for providing positioning service for a mobile device, the method comprising:
obtaining at least one temperature associated with the mobile device;
determining a level of service of a positioning function of the mobile device, corresponding to one or more available positioning operations, and one or more selected positioning operations from the one or more available positioning operations, based on the at least one temperature exceeding at least one first temperature threshold; and
determining position information based on the one or more selected positioning operations of the one or more available positioning operations, the position information including one or more positioning signal measurements, or one or more position estimates, or any combination thereof.

Clause 2. The method of clause 1, wherein determining the one or more selected positioning operations comprises at least one of:
determining a positioning signal measurement accuracy;
determining a positioning signal measurement frequency;
determining a position estimation accuracy;
determining a time allowed for the one or more selected positioning operations;
determining a time allowed for the positioning function;
determining a number of positioning signals measured by the mobile device;
determining a number of positioning signal measurements by the mobile device;
determining a number of types of positioning signal measurements by the mobile device;
determining a number of types of positioning signals measured by the mobile device; and
determining to omit at least one of the one or more available positioning operations from the one or more selected positioning operations.

Clause 3. The method of clause 2, wherein determining the one or more selected positioning operations includes omitting use of at least one of L2-band satellite signals and L5-band satellite signals from the one or more selected positioning operations.

Clause 4. The method of clause 2, wherein determining the one or more selected positioning operations includes determining a number of satellites from which positioning signals are measured by the mobile device.

Clause 5. The method of clause 2, wherein determining the one or more selected positioning operations of the positioning function includes increasing a satellite signal measurement time to up to one minute.

Clause 6. The method of clause 1, wherein determining the level of service of the positioning function comprises reducing the level of service of the positioning function to different levels of service in a prioritized order of level of service, comprising:
determining the level of service of the positioning function to be a first level based on the at least one temperature exceeding at least one first temperature threshold; and
determining the level of service of the positioning function to be a second level based on the at least one temperature exceeding at least one second temperature threshold that is higher than the at least one first temperature threshold;
wherein the second level corresponds to reduced positioning functionality relative to the first level.

Clause 7. The method of clause 6, wherein determining the level of service of the positioning function comprises:
reducing a level of service of at least one of the one or more selected positioning operations to a third level based on the at least one temperature exceeding the at least one first temperature threshold; and
based on the at least one temperature exceeding the at least one second temperature threshold, at least one of:
   reducing a level of service of at least another one of the one or more selected positioning operations; and
   reducing the level of service of the at least one of the one or more selected positioning operations to a fourth level, wherein the fourth level corresponds to reduced positioning functionality relative to the third level.

Clause 8. The method of clause 6, wherein the reduced positioning functionality includes at least one of:
a reduced positioning signal measurement accuracy;
a reduced positioning signal measurement frequency;
a reduced position estimation accuracy;
increased time allowed for the one or more selected positioning operations;
increased time allowed for the positioning function;
a reduced number of positioning signals measured by the mobile device;
a reduced number of positioning signal measurements by the mobile device;
a reduced number of types of positioning signal measurements by the mobile device;
a reduced number of types of positioning signals measured by the mobile device; and
omission of at least one of the one or more available positioning operations from the one or more selected positioning operations.

Clause 9. The method of clause 6, wherein the prioritized order of level of service depends on a location of the mobile device.

Clause 10. The method of clause 6, wherein reducing the level of service of the positioning function to different levels of service in the prioritized order of level of service comprises eliminating use of signals from satellite constellations according to a prioritized constellation order.

Clause 11. The method of clause 10, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

Clause 12. The method of clause 1, wherein the at least one temperature includes at least one of an internal temperature of the mobile device and an environmental temperature external to the mobile device.

Clause 13. The method of clause 12, wherein determining the level of service of the positioning function of the mobile device comprises determining the level of service of the positioning function of the mobile device based on a function of the internal temperature and the environmental temperature exceeding the at least one first temperature threshold.

Clause 14. The method of clause 1, wherein which of the one or more available positioning operations comprise the one or more selected positioning operations depends on a location of the mobile device.

Clause 15. The method of clause 1, wherein the method is performed by the mobile device, the method further comprising transmitting, from the mobile device to a network entity, an indication of the level of service of the positioning function to be implemented by the mobile device.

Clause 16. The method of clause 1, wherein the method is performed by the mobile device, the method further comprising transmitting, from the mobile device to a network entity, an indication of a preferred positioning method of the mobile device based on reduction of the level of service of the positioning function.

Clause 17. The method of clause 1, wherein the method is performed by a network entity, the method further comprising transmitting, from the network entity to the mobile device, an instruction for the mobile device to reduce the level of service of the positioning function.

Clause 18. The method of clause 1, wherein the method is performed by a network entity, the method further comprising reducing, by the network entity, a number of positioning signal measurements scheduled for the mobile device.

Clause 19. The method of clause 1, wherein the method is performed by a network entity, the method further comprising reducing, by the network entity, a frequency of scheduled location reporting by the mobile device.

Clause 20. An apparatus comprising:
at least one memory;
at least one transceiver; and
at least one processor, communicatively coupled to the at least one memory and the at least one transceiver, configured to:
   obtain at least one temperature associated with a mobile device;
   determine a level of service of a positioning function of the mobile device, corresponding to one or more available positioning operations, and one or more selected positioning operations from the one or more available positioning operations, based on the at least one temperature exceeding at least one first temperature threshold; and
   determine position information based on the one or more selected positioning operations of the one or more available positioning operations, the position information including one or more positioning signal measurements, or one or more position estimates, or any combination thereof.

Clause 21. The apparatus of clause 20, wherein to determine the one or more selected positioning operations the at least one processor is further configured to at least one of:
determine a positioning signal measurement accuracy;
determine a positioning signal measurement frequency;
determine a position estimation accuracy;
determine a time allowed for the one or more selected positioning operations;
determine a time allowed for the positioning function;
determine a number of positioning signals measured by the mobile device;
determine a number of positioning signal measurements by the mobile device;
determine a number of types of positioning signal measurements by the mobile device;
determine a number of types of positioning signals measured by the mobile device; and
determine to omit the at least one of the one or more available positioning operations from the one or more selected positioning operations.

Clause 22. The apparatus of clause 21, wherein to determine the one or more selected positioning operations the at least one processor is configured to omit use of at least one of L2-band satellite signals and L5-band satellite signals from the one or more selected positioning operations.

Clause 23. The apparatus of clause 21, wherein to determine the one or more selected positioning operations the at least one processor is configured to determine a number of satellites from which positioning signals are measured by the mobile device.

Clause 24. The apparatus of clause 21, wherein to determine the one or more selected positioning operations of the positioning function the at least one processor is configured to increase a satellite signal measurement time to up to one minute.

Clause 25. The apparatus of clause 20, wherein to determine the level of service of the positioning function the at least one processor is configured, in order to reduce the level of service of the positioning function to different levels of service in a prioritized order of level of service, to:
determine the level of service of the positioning function to be a first level based on the at least one temperature exceeding at least one first temperature threshold; and
determine the level of service of the positioning function to be a second level based on the at least one temperature exceeding at least one second temperature threshold that is higher than the at least one first temperature threshold;
wherein the second level corresponds to reduced positioning functionality relative to the first level.

Clause 26. The apparatus of clause 25, wherein to determine the level of service of the positioning function the at least one processor is configured to:
reduce a level of service of at least one of the one or more selected positioning operations to a third level based on the at least one temperature exceeding the at least one first temperature threshold; and
based on the at least one temperature exceeding the at least one second temperature threshold, at least one of:
   reduce a level of service of at least another one of the one or more selected positioning operations; and
   reduce the level of service of the at least one of the one or more selected positioning operations to a fourth level, wherein the fourth level corresponds to reduced positioning functionality relative to the third level.

Clause 27. The apparatus of clause 25, wherein, in order to reduce the level of service of the positioning function, the at least one processor is configured to at least one of:
reduce positioning signal measurement accuracy;
reduce positioning signal measurement frequency;
reduce position estimation accuracy;
increase time allowed for the one or more selected positioning operations;
increase time allowed for the positioning function;
reduce a number of positioning signals measured by the mobile device;
reduce a number of positioning signal measurements by the mobile device;
reduce a number of types of positioning signal measurements by the mobile device;
reduce a number of types of positioning signals measured by the mobile device; and
omit at least one of the one or more available positioning operations from the one or more selected positioning operations.

Clause 28. The apparatus of clause 25, wherein the prioritized order of level of service depends on a location of the mobile device.

Clause 29. The apparatus of clause 25, wherein to reduce the level of service of the positioning function to different levels of service in the prioritized order of level of service the at least one processor is configured to eliminate use of signals from satellite constellations according to a prioritized constellation order.

Clause 30. The apparatus of clause 29, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

Clause 31. The apparatus of clause 20, wherein the at least one temperature includes at least one of an internal temperature of the mobile device, or an environmental temperature external to the mobile device.

Clause 32. The apparatus of clause 31, wherein to determine the level of service of the positioning function of the mobile device the at least one processor is configured to determine the level of service of the positioning function of the mobile device based on a function of the internal temperature and the environmental temperature exceeding the at least one first temperature threshold.

Clause 33. The apparatus of clause 20, wherein which of the one or more available positioning operations comprise the one or more selected positioning operations depends on a location of the mobile device.

Clause 34. The apparatus of clause 20, wherein the apparatus is the mobile device and wherein the at least one processor is configured to transmit, via the at least one transceiver to a network entity, an indication of the level of service of the positioning function to be implemented by the mobile device.

Clause 35. The apparatus of clause 20, wherein the apparatus is the mobile device and wherein the at least one processor is configured to transmit, via the at least one transceiver to a network entity, an indication of a preferred positioning method of the mobile device based on reduction of the level of service of the positioning function.

Clause 36. The apparatus of clause 20, wherein the apparatus is a network entity and wherein the at least one processor is configured to transmit, via the at least one transceiver to the mobile device, an instruction for the mobile device to reduce the level of service of the positioning function.

Clause 37. The apparatus of clause 20, wherein the apparatus is a network entity and wherein the at least one processor is configured to reduce a number of positioning signal measurements scheduled for the mobile device.

Clause 38. The apparatus of clause 20, wherein the apparatus is a network entity and wherein the at least one processor is configured to reduce a frequency of scheduled location reporting by the mobile device.

Clause 39. An apparatus comprising:
means for obtaining at least one temperature associated with a mobile device;
means for determining a level of service of a positioning function of the mobile device, corresponding to one or more available positioning operations, and one or more selected positioning operations from the one or more available positioning operations, based on the at least one temperature exceeding at least one first temperature threshold; and
means for determining position information based on the one or more selected positioning operations of the one or more available positioning operations, the position information including one or more positioning signal measurements, or one or more position estimates, or any combination thereof.

Clause 40. The apparatus of clause 39, wherein the means for determining the one or more selected positioning operations comprise at least one of:
means for determining a positioning signal measurement accuracy;
means for determining a positioning signal measurement frequency;
means for determining a position estimation accuracy;
means for determining a time allowed for the one or more selected positioning operations;
means for determining a time allowed for the positioning function;
means for determining a number of positioning signals measured by the mobile device;
means for determining a number of positioning signal measurements by the mobile device;
means for determining a number of types of positioning signal measurements by the mobile device;
means for determining a number of types of positioning signals measured by the mobile device; and
means for determining to omit at least one of the one or more available positioning operations from the one or more selected positioning operations.

Clause 41. The apparatus of clause 40, wherein the means for determining the one or more selected positioning operations include means for omitting use of at least one of L2-band satellite signals and L5-band satellite signals from the one or more selected positioning operations.

Clause 42. The apparatus of clause 40, wherein the means for determining the one or more selected positioning operations include means for determining a number of satellites from which positioning signals are measured by the mobile device.

Clause 43. The apparatus of clause 40, wherein the means for determining the one or more selected positioning operations of the positioning function include means for increasing a satellite signal measurement time to up to one minute.

Clause 44. The apparatus of clause 39, wherein the means for determining the level of service of the positioning function comprise means for reducing the level of service of the positioning function to different levels of service in a prioritized order of level of service, comprising:
means for determining the level of service of the positioning function to be a first level based on the at least one temperature exceeding at least one first temperature threshold; and
means for determining the level of service of the positioning function to be a second level based on the at least one temperature exceeding at least one second temperature threshold that is higher than the at least one first temperature threshold;
wherein the second level corresponds to reduced positioning functionality relative to the first level.

Clause 45. The apparatus of clause 44, wherein the means for determining the level of service of the positioning function comprise:
means for reducing a level of service of at least one of the one or more selected positioning operations to a third level based on the at least one temperature exceeding the at least one first temperature threshold; and
means for, based on the at least one temperature exceeding the at least one second temperature threshold, at least one of:
   reducing a level of service of at least another one of the one or more selected positioning operations; and
   reducing the level of service of the at least one of the one or more selected positioning operations to a fourth level, wherein the fourth level corresponds to reduced positioning functionality relative to the third level.

Clause 46. The apparatus of clause 44, wherein the reduced positioning functionality includes at least one of:
a reduced positioning signal measurement accuracy;
a reduced positioning signal measurement frequency;
a reduced position estimation accuracy;
increased time allowed for the one or more selected positioning operations;
increased time allowed for the positioning function;
a reduced number of positioning signals measured by the mobile device;
a reduced number of positioning signal measurements by the mobile device;
a reduced number of types of positioning signal measurements by the mobile device;
a reduced number of types of positioning signals measured by the mobile device; and
omission of at least one of the one or more available positioning operations from the one or more selected positioning operations.

Clause 47. The apparatus of clause 44, wherein the prioritized order of level of service depends on a location of the mobile device.

Clause 48. The apparatus of clause 44, wherein the means for reducing the level of service of the positioning function to different levels of service in the prioritized order of level of service comprise means for eliminating use of signals from satellite constellations according to a prioritized constellation order.

Clause 49. The apparatus of clause 48, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

Clause 50. The apparatus of clause 39, wherein the at least one temperature includes at least one of an internal temperature of the mobile device and an environmental temperature external to the mobile device.

Clause 51. The apparatus of clause 50, wherein the means for determining the level of service of the positioning function of the mobile device comprise means for determining the level of service of the positioning function of the mobile device based on a function of the internal temperature and the environmental temperature exceeding the at least one first temperature threshold.

Clause 52. The apparatus of clause 39, wherein which of the one or more available positioning operations comprise the one or more selected positioning operations depends on a location of the mobile device.

Clause 53. The apparatus of clause 39, wherein the apparatus is the mobile device and the apparatus further comprises means for transmitting, to a network entity, an indication of the level of service of the positioning function to be implemented by the mobile device.

Clause 54. The apparatus of clause 39, wherein the apparatus is the mobile device and the apparatus further comprises means for transmitting, to a network entity, an indication of a preferred positioning method of the mobile device based on reduction of the level of service of the positioning function.

Clause 55. The apparatus of clause 39, wherein the apparatus is a network entity and the apparatus further comprises means for transmitting, to the mobile device, an instruction for the mobile device to reduce the level of service of the positioning function.

Clause 56. The apparatus of clause 39, wherein the apparatus is a network entity and the apparatus further comprises means for reducing a number of positioning signal measurements scheduled for the mobile device.

Clause 57. The apparatus of clause 39, wherein the apparatus is a network entity and the apparatus further comprises means for reducing a frequency of scheduled location reporting by the mobile device.

Clause 58. A non-transitory, processor-readable storage medium comprising processor-readable instructions to cause at least one processor of an apparatus, for providing positioning service for a mobile device, to:
obtain at least one temperature associated with the mobile device;
determine a level of service of a positioning function of the mobile device, corresponding to one or more available positioning operations, and one or more selected positioning operations from the one or more available positioning operations, based on the at least one temperature exceeding at least one first temperature threshold; and
determine position information based on the one or more selected positioning operations of the one or more available positioning operations, the position information including one or more positioning signal measurements, or one or more position estimates, or any combination thereof.

Clause 59. The non-transitory, processor-readable storage medium of clause 58, wherein the processor-readable instructions to cause the at least one processor to determine the one or more selected positioning operations comprise at least one of:
processor-readable instructions to cause the at least one processor to determine a positioning signal measurement accuracy;
processor-readable instructions to cause the at least one processor to determine a positioning signal measurement frequency;
processor-readable instructions to cause the at least one processor to determine a position estimation accuracy;
processor-readable instructions to cause the at least one processor to determine a time allowed for the one or more selected positioning operations;
processor-readable instructions to cause the at least one processor to determine a time allowed for the positioning function;
processor-readable instructions to cause the at least one processor to determine a number of positioning signals measured by the mobile device;
processor-readable instructions to cause the at least one processor to determine a number of positioning signal measurements by the mobile device;
processor-readable instructions to cause the at least one processor to determine a number of types of positioning signal measurements by the mobile device;
processor-readable instructions to cause the at least one processor to determine a number of types of positioning signals measured by the mobile device; and
processor-readable instructions to cause the at least one processor to determine to omit at least one of the one or more available positioning operations from the one or more selected positioning operations.

Clause 60. The non-transitory, processor-readable storage medium of clause 59, wherein the processor-readable instructions to cause the at least one processor to determine the one or more selected positioning operations include processor-readable instructions to cause the at least one processor to omit use of at least one of L2-band satellite signals and L5-band satellite signals from the one or more selected positioning operations.

Clause 61. The non-transitory, processor-readable storage medium of clause 59, wherein the processor-readable instructions to cause the at least one processor to determine the one or more selected positioning operations include processor-readable instructions to cause the at least one processor to determine a number of satellites from which positioning signals are measured by the mobile device.

Clause 62. The non-transitory, processor-readable storage medium of clause 59, wherein the processor-readable instructions to cause the at least one processor to determine the one or more selected positioning operations of the positioning function include processor-readable instructions to cause the at least one processor to increase a satellite signal measurement time to up to one minute.

Clause 63. The non-transitory, processor-readable storage medium of clause 58, wherein the processor-readable instructions to cause the at least one processor to determine the level of service of the positioning function comprise processor-readable instructions to cause the at least one processor, in order to reduce the level of service of the positioning function to different levels of service in a prioritized order of level of service, to:
determine the level of service of the positioning function to be a first level based on the at least one temperature exceeding at least one first temperature threshold; and
determine the level of service of the positioning function to be a second level based on the at least one temperature exceeding at least one second temperature threshold that is higher than the at least one first temperature threshold;
wherein the second level corresponds to reduced positioning functionality relative to the first level.

Clause 64. The non-transitory, processor-readable storage medium of clause 63, wherein the processor-readable instructions to cause the at least one processor to determine the level of service of the positioning function comprise:
processor-readable instructions to cause the at least one processor to reduce a level of service of at least one of the one or more selected positioning operations to a third level based on the at least one temperature exceeding the at least one first temperature threshold; and
processor-readable instructions to cause the at least one processor to, based on the at least one temperature exceeding the at least one second temperature threshold, at least one of:
   reduce a level of service of at least another one of the one or more selected positioning operations; and
   reduce the level of service of the at least one of the one or more selected positioning operations to a fourth level, wherein the fourth level corresponds to reduced positioning functionality relative to the third level.

Clause 65. The non-transitory, processor-readable storage medium of clause 63, wherein the reduced positioning functionality includes at least one of:
a reduced positioning signal measurement accuracy;
a reduced positioning signal measurement frequency;
a reduced position estimation accuracy;
increased time allowed for the one or more selected positioning operations;
increased time allowed for the positioning function;
a reduced number of positioning signals measured by the mobile device;
a reduced number of positioning signal measurements by the mobile device;
a reduced number of types of positioning signal measurements by the mobile device;
a reduced number of types of positioning signals measured by the mobile device; and
omission of at least one of the one or more available positioning operations from the one or more selected positioning operations.

Clause 66. The non-transitory, processor-readable storage medium of clause 63, wherein the prioritized order of level of service depends on a location of the mobile device.

Clause 67. The non-transitory, processor-readable storage medium of clause 63, wherein the processor-readable instructions to cause the at least one processor to reduce the level of service of the positioning function to different levels of service in the prioritized order of level of service comprise processor-readable instructions to cause the at least one processor to eliminate use of signals from satellite constellations according to a prioritized constellation order.

Clause 68. The non-transitory, processor-readable storage medium of clause 67, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

Clause 69. The non-transitory, processor-readable storage medium of clause 58, wherein the at least one temperature includes at least one of an internal temperature of the mobile device and an environmental temperature external to the mobile device.

Clause 70. The non-transitory, processor-readable storage medium of clause 69, wherein the processor-readable instructions to cause the at least one processor to determine the level of service of the positioning function of the mobile device comprise processor-readable instructions to cause the at least one processor to determine the level of service of the positioning function of the mobile device based on a function of the internal temperature and the environmental temperature exceeding the at least one first temperature threshold.

Clause 71. The non-transitory, processor-readable storage medium of clause 58, wherein which of the one or more available positioning operations comprise the one or more selected positioning operations depends on a location of the mobile device.

Clause 72. The non-transitory, processor-readable storage medium of clause 58, wherein the apparatus is the mobile device and the non-transitory, processor-readable storage medium further comprises processor-readable instructions to cause the at least one processor to transmit, to a network entity, an indication of the level of service of the positioning function to be implemented by the mobile device.

Clause 73. The non-transitory, processor-readable storage medium of clause 58, wherein the apparatus is the mobile device and the non-transitory, processor-readable storage medium further comprises processor-readable instructions to cause the at least one processor to transmit, to a network entity, an indication of a preferred positioning method of the mobile device based on reduction of the level of service of the positioning function.

Clause 74. The non-transitory, processor-readable storage medium of clause 58, wherein the apparatus is a network entity and the non-transitory, processor-readable storage medium further comprises processor-readable instructions to cause the at least one processor to transmit, to the mobile device, an instruction for the mobile device to reduce the level of service of the positioning function.

Clause 75. The non-transitory, processor-readable storage medium of clause 58, wherein the apparatus is a network entity and the non-transitory, processor-readable storage medium further comprises processor-readable instructions to cause the at least one processor to reduce a number of positioning signal measurements scheduled for the mobile device.

Clause 76. The non-transitory, processor-readable storage medium of clause 58, wherein the apparatus is a network entity and the non-transitory, processor-readable storage medium further comprises processor-readable instructions to cause the at least one processor to reduce a frequency of scheduled location reporting by the mobile device.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method for providing positioning service for a mobile device, the method comprising:
obtaining at least one temperature associated with the mobile device;
determining a level of service of a positioning function of the mobile device, corresponding to one or more available positioning operations, and one or more selected positioning operations from the one or more available positioning operations, based on the at least one temperature exceeding at least one first temperature threshold; and
determining position information based on the one or more selected positioning operations of the one or more available positioning operations, the position information including one or more positioning signal measurements, or one or more position estimates, or any combination thereof.

2. The method of claim 1, wherein determining the one or more selected positioning operations comprises at least one of:
determining a positioning signal measurement accuracy;
determining a positioning signal measurement frequency;
determining a position estimation accuracy;
determining a time allowed for the one or more selected positioning operations;
determining a time allowed for the positioning function;
determining a number of positioning signals measured by the mobile device;
determining a number of positioning signal measurements by the mobile device;
determining a number of types of positioning signal measurements by the mobile device;
determining a number of types of positioning signals measured by the mobile device; and
determining to omit at least one of the one or more available positioning operations from the one or more selected positioning operations.

3. The method of claim 2, wherein determining the one or more selected positioning operations includes omitting use of at least one of L2-band satellite signals and L5-band satellite signals from the one or more selected positioning operations.

4. The method of claim 2, wherein determining the one or more selected positioning operations includes determining a number of satellites from which positioning signals are measured by the mobile device.

5. The method of claim 2, wherein determining the one or more selected positioning operations of the positioning function includes increasing a satellite signal measurement time to up to one minute.

6. The method of claim 1, wherein determining the level of service of the positioning function comprises reducing the level of service of the positioning function to different levels of service in a prioritized order of level of service, comprising:
determining the level of service of the positioning function to be a first level based on the at least one temperature exceeding at least one first temperature threshold; and
determining the level of service of the positioning function to be a second level based on the at least one temperature exceeding at least one second temperature threshold that is higher than the at least one first temperature threshold;
wherein the second level corresponds to reduced positioning functionality relative to the first level.

7. The method of claim 6, wherein determining the level of service of the positioning function comprises:
reducing a level of service of at least one of the one or more selected positioning operations to a third level based on the at least one temperature exceeding the at least one first temperature threshold; and
based on the at least one temperature exceeding the at least one second temperature threshold, at least one of:
reducing a level of service of at least another one of the one or more selected positioning operations; and
reducing the level of service of the at least one of the one or more selected positioning operations to a fourth level, wherein the fourth level corresponds to reduced positioning functionality relative to the third level.

8. The method of claim 6, wherein the reduced positioning functionality includes at least one of:
a reduced positioning signal measurement accuracy;
a reduced positioning signal measurement frequency;
a reduced position estimation accuracy;
increased time allowed for the one or more selected positioning operations;
increased time allowed for the positioning function;
a reduced number of positioning signals measured by the mobile device;
a reduced number of positioning signal measurements by the mobile device;
a reduced number of types of positioning signal measurements by the mobile device;
a reduced number of types of positioning signals measured by the mobile device; and
omission of at least one of the one or more available positioning operations from the one or more selected positioning operations.

9. The method of claim 6, wherein the prioritized order of level of service depends on a location of the mobile device.

10. The method of claim 6, wherein reducing the level of service of the positioning function to different levels of service in the prioritized order of level of service comprises eliminating use of signals from satellite constellations according to a prioritized constellation order.

11. The method of claim 10, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

12. The method of claim 1, wherein the at least one temperature includes at least one of an internal temperature of the mobile device and an environmental temperature external to the mobile device.

13. The method of claim 12, wherein determining the level of service of the positioning function of the mobile device comprises determining the level of service of the positioning function of the mobile device based on a function of the internal temperature and the environmental temperature exceeding the at least one first temperature threshold.

14. The method of claim 1, wherein which of the one or more available positioning operations comprise the one or more selected positioning operations depends on a location of the mobile device.

15. The method of claim 1, wherein the method is performed by the mobile device, the method further comprising transmitting, from the mobile device to a network entity, an indication of the level of service of the positioning function to be implemented by the mobile device.

16. The method of claim 1, wherein the method is performed by the mobile device, the method further comprising transmitting, from the mobile device to a network entity, an indication of a preferred positioning method of the mobile device based on reduction of the level of service of the positioning function.

17. The method of claim 1, wherein the method is performed by a network entity, the method further comprising transmitting, from the network entity to the mobile device, an instruction for the mobile device to reduce the level of service of the positioning function.

18. The method of claim 1, wherein the method is performed by a network entity, the method further comprising reducing, by the network entity, a number of positioning signal measurements scheduled for the mobile device.

19. The method of claim 1, wherein the method is performed by a network entity, the method further comprising reducing, by the network entity, a frequency of scheduled location reporting by the mobile device.

20. An apparatus comprising:
at least one memory;
at least one transceiver; and
at least one processor, communicatively coupled to the at least one memory and the at least one transceiver, configured to:
obtain at least one temperature associated with a mobile device;
determine a level of service of a positioning function of the mobile device, corresponding to one or more available positioning operations, and one or more selected positioning operations from the one or more available positioning operations, based on the at least one temperature exceeding at least one first temperature threshold; and
determine position information based on the one or more selected positioning operations of the one or more available positioning operations, the position information including one or more positioning signal measurements, or one or more position estimates, or any combination thereof.

21. The apparatus of claim 20, wherein to determine the one or more selected positioning operations the at least one processor is further configured to at least one of:
determine a positioning signal measurement accuracy;
determine a positioning signal measurement frequency;
determine a position estimation accuracy;
determine a time allowed for the one or more selected positioning operations;
determine a time allowed for the positioning function;
determine a number of positioning signals measured by the mobile device;
determine a number of positioning signal measurements by the mobile device;
determine a number of types of positioning signal measurements by the mobile device;
determine a number of types of positioning signals measured by the mobile device; and
determine to omit the at least one of the one or more available positioning operations from the one or more selected positioning operations.

22. The apparatus of claim 21, wherein to determine the one or more selected positioning operations the at least one processor is configured to omit use of at least one of L2-band satellite signals and L5-band satellite signals from the one or more selected positioning operations.

23. The apparatus of claim 21, wherein to determine the one or more selected positioning operations the at least one processor is configured to determine a number of satellites from which positioning signals are measured by the mobile device.

24. The apparatus of claim 21, wherein to determine the one or more selected positioning operations of the positioning function the at least one processor is configured to increase a satellite signal measurement time to up to one minute.

25. The apparatus of claim 20, wherein to determine the level of service of the positioning function the at least one processor is configured, in order to reduce the level of service of the positioning function to different levels of service in a prioritized order of level of service, to:
determine the level of service of the positioning function to be a first level based on the at least one temperature exceeding at least one first temperature threshold; and
determine the level of service of the positioning function to be a second level based on the at least one temperature exceeding at least one second temperature threshold that is higher than the at least one first temperature threshold;
wherein the second level corresponds to reduced positioning functionality relative to the first level.

26. The apparatus of claim 25, wherein to determine the level of service of the positioning function the at least one processor is configured to:
reduce a level of service of at least one of the one or more selected positioning operations to a third level based on the at least one temperature exceeding the at least one first temperature threshold; and
based on the at least one temperature exceeding the at least one second temperature threshold, at least one of:
reduce a level of service of at least another one of the one or more selected positioning operations; and
reduce the level of service of the at least one of the one or more selected positioning operations to a fourth level, wherein the fourth level corresponds to reduced positioning functionality relative to the third level.

27. The apparatus of claim 25, wherein, in order to reduce the level of service of the positioning function, the at least one processor is configured to at least one of:
reduce positioning signal measurement accuracy;
reduce positioning signal measurement frequency;
reduce position estimation accuracy;
increase time allowed for the one or more selected positioning operations;
increase time allowed for the positioning function;
reduce a number of positioning signals measured by the mobile device;
reduce a number of positioning signal measurements by the mobile device;
reduce a number of types of positioning signal measurements by the mobile device;
reduce a number of types of positioning signals measured by the mobile device; and
omit at least one of the one or more available positioning operations from the one or more selected positioning operations.

28. The apparatus of claim 25, wherein the prioritized order of level of service depends on a location of the mobile device.

29. The apparatus of claim 25, wherein to reduce the level of service of the positioning function to different levels of service in the prioritized order of level of service the at least one processor is configured to eliminate use of signals from satellite constellations according to a prioritized constellation order.

30. The apparatus of claim 29, wherein the prioritized constellation order comprises, in order of priority from lower priority of signal use to higher priority of signal use, IRNSS (Indian Regional Navigational Satellite System) signals, Beidou signals, GLONASS signals, and Galileo signals.

31. The apparatus of claim 20, wherein the at least one temperature includes at least one of an internal temperature of the mobile device, or an environmental temperature external to the mobile device.

32. The apparatus of claim 31, wherein to determine the level of service of the positioning function of the mobile device the at least one processor is configured to determine the level of service of the positioning function of the mobile device based on a function of the internal temperature and the environmental temperature exceeding the at least one first temperature threshold.

33. The apparatus of claim 20, wherein which of the one or more available positioning operations comprise the one or more selected positioning operations depends on a location of the mobile device.

34. The apparatus of claim 20, wherein the apparatus is the mobile device and wherein the at least one processor is configured to transmit, via the at least one transceiver to a network entity, an indication of the level of service of the positioning function to be implemented by the mobile device.

35. The apparatus of claim 20, wherein the apparatus is the mobile device and wherein the at least one processor is configured to transmit, via the at least one transceiver to a network entity, an indication of a preferred positioning method of the mobile device based on reduction of the level of service of the positioning function.

36. The apparatus of claim 20, wherein the apparatus is a network entity and wherein the at least one processor is configured to transmit, via the at least one transceiver to the mobile device, an instruction for the mobile device to reduce the level of service of the positioning function.

37. The apparatus of claim 20, wherein the apparatus is a network entity and wherein the at least one processor is configured to reduce a number of positioning signal measurements scheduled for the mobile device.

38. The apparatus of claim 20, wherein the apparatus is a network entity and wherein the at least one processor is configured to reduce a frequency of scheduled location reporting by the mobile device.

39. An apparatus comprising:
means for obtaining at least one temperature associated with a mobile device;
means for determining a level of service of a positioning function of the mobile device, corresponding to one or more available positioning operations, and one or more selected positioning operations from the one or more available positioning operations, based on the at least one temperature exceeding at least one first temperature threshold; and
means for determining position information based on the one or more selected positioning operations of the one or more available positioning operations, the position information including one or more positioning signal measurements, or one or more position estimates, or any combination thereof.

40. The apparatus of claim 39, wherein the means for determining the one or more selected positioning operations comprise at least one of:
means for determining a positioning signal measurement accuracy;
means for determining a positioning signal measurement frequency;
means for determining a position estimation accuracy;
means for determining a time allowed for the one or more selected positioning operations;
means for determining a time allowed for the positioning function;
means for determining a number of positioning signals measured by the mobile device;
means for determining a number of positioning signal measurements by the mobile device;
means for determining a number of types of positioning signal measurements by the mobile device;
means for determining a number of types of positioning signals measured by the mobile device; and
means for determining to omit at least one of the one or more available positioning operations from the one or more selected positioning operations.
